(19) United States
(12) Patent Application Publication
(10) Pub. No.: US 2025/0329256 A1
(43) Pub. Date: Oct. 23, 2025

(54) GENERATING RESPONSES TO QUERIES BASED ON MESSAGES

(71) Applicant: QUALCOMM Incorporated, San Diego, CA (US)

(72) Inventors: Anantharaman BALASUBRAMANIAN, San Diego, CA (US); Varun RAVI KUMAR, San Diego, CA (US); Senthil Kumar YOGAMANI, Headford (IE); Arvind Vardarajan SANTHANAM, San Diego, CA (US); Dan VASSILOVSKI, Del Mar, CA (US)

(21) Appl. No.: 18/638,507

(22) Filed: Apr. 17, 2024

(51) Int. Cl. G08G 1/0968; G06F 40/40; G08G 1/09; H04W 4/40

(52) U.S. Cl. CPC G08G 1/096888; G06F 40/40; G08G 1/091; H04W 4/40

(57) ABSTRACT

Systems and techniques are described herein for responding to queries. For instance, a method for responding to queries is provided. The method may include obtaining a plurality of vehicle to everything (V2X) messages, each V2X message of the plurality of V2X messages comprising a plurality of fields; obtaining a query from an occupant of a vehicle; determining V2X information comprising at least one field of at least one V2X message of the plurality of V2X messages; and processing the query and the determined V2X information using a machine-learning model to generate a response to the query.

### TECHNICAL FIELD

The present disclosure generally relates to generating responses to queries. For example, aspects of the present disclosure include systems and techniques for generating responses to queries based on messages (e.g., vehicle-to-everything (V2X) messages).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is fifth generation (5G) New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Aspects of wireless communication may allow for communication between devices, such as in vehicle-to-everything (V2X), vehicle-to-vehicle (V2V), car-to-cloud (C2C), and/or device-to-device (D2D) communication. As an example of V2X communications, a vehicle may include a computing system and may communicate with other vehicles (e.g., V2V communication). Further, the vehicles may communicate with roadside units (RSUs), such as stationary cameras (e.g., traffic cameras). Further still, the vehicles may communicate with user equipment (UEs) (e.g., smart phones or wearable computing devices) of vulnerable road users (VRUs), such as pedestrians, cyclists, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for responding to queries. According to at least one example, a method is provided for responding to queries. The method includes: obtaining a plurality of vehicle to everything (V2X) messages, each V2X message of the plurality of V2X messages comprising a plurality of fields; obtaining a query from an occupant of a vehicle; determining V2X information comprising at least one field of at least one V2X message of the plurality of V2X messages; and processing the query and the determined V2X information using a machine-learning model to generate a response to the query.

In another example, an apparatus for responding to queries is provided that includes at least one memory and at least one processor (e.g., configured in circuitry) coupled to the at least one memory. The at least one processor configured to: obtain a plurality of vehicle to everything (V2X) messages, each V2X message of the plurality of V2X messages comprising a plurality of fields; obtain a query from an occupant of a vehicle; determine V2X information comprising at least one field of at least one V2X message of the plurality of V2X messages; and process the query and the determined V2X information using a machine-learning model to generate a response to the query.

In another example, a non-transitory computer-readable medium is provided that has stored thereon instructions that, when executed by one or more processors, cause the one or more processors to: obtain a plurality of vehicle to everything (V2X) messages, each V2X message of the plurality of V2X messages comprising a plurality of fields; obtain a query from an occupant of a vehicle; determine V2X information comprising at least one field of at least one V2X message of the plurality of V2X messages; and process the query and the determined V2X information using a machine-learning model to generate a response to the query.

In another example, an apparatus for responding to queries is provided. The apparatus includes: means for obtaining a plurality of vehicle to everything (V2X) messages, each V2X message of the plurality of V2X messages comprising a plurality of fields; means for obtaining a query from an occupant of a vehicle; means for determining V2X information comprising at least one field of at least one V2X message of the plurality of V2X messages; and means for processing the query and the determined V2X information using a machine-learning model to generate a response to the query.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or another device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example wireless communications system, according to various aspects of the present disclosure;

FIG. 2 is a diagram illustrating an example of a disaggregated base station architecture, which may be employed by the disclosed systems and methods for a robust and enhanced detection of position overlap (PO) of vehicles, according to various aspects of the present disclosure;

FIG. 3 is a diagram illustrating an example of various user equipment (UEs) communicating over direct communication interfaces (e.g., a cellular based PC5 sidelink interface, 802.11p defined DSRC interface, or other direct interface) and wide area network (Uu) interfaces, according to various aspects of the present disclosure;

FIG. 4 is a block diagram illustrating an example of a computing system of a vehicle, according to various aspects of the present disclosure;

FIG. 5 is a block diagram illustrating an example of a computing system of a user device, according to various aspects of the present disclosure;

FIG. 6 is a diagram illustrating an example of devices involved in wireless communications (e.g., sidelink communications), according to various aspects of the present disclosure;

FIG. 7 is a diagram illustrating an example of a system for sensor sharing (which may alternatively be referred to as “collective perception”) in wireless communications (e.g., C-V2X communications), according to various aspects of the present disclosure;

FIG. 8 is a block diagram illustrating an example system for generating a response to a query, according to various aspects of the present disclosure;

FIG. 9 is a block diagram illustrating another example system for generating a response to a query, according to various aspects of the present disclosure;

FIG. 10 is a block diagram illustrating an example environment in which a vehicle may determine and provide responses to queries, according to various aspects of the present disclosure;

FIG. 11 is a swimlane diagram illustrating an example process for generating a response to a query, according to various aspects of the present disclosure;

FIG. 12 is a swimlane diagram illustrating another example process for generating a response to a query, according to various aspects of the present disclosure;

FIG. 13 is a flow diagram illustrating another example process for generating a response to a query, in accordance with aspects of the present disclosure;

FIG. 14 is a block diagram illustrating an example of a deep learning neural network that can be used to perform various tasks, according to some aspects of the disclosed technology;

FIG. 15 is a block diagram illustrating an example of a convolutional neural network (CNN), according to various aspects of the present disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of devices or systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), car-to-cloud (C2C), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources including personal device of pedestrians and roadside units, such as traffic cameras) through wireless links to allow the information to be communicated to other vehicles, pedestrians, and/or traffic infrastructure. The information may be transmitted using one or more vehicle-based messages, such as C-V2X messages, which can include Sensor Data Sharing Messages (SDSMs) (e.g., defined by Society of Automotive Engineers (SAE) Standard Document J3224) used by vehicles or other devices to share sensor information, Basic Safety Messages (BSMs) (e.g., defined by SAE J2735) used by vehicles or other devices to share safety-based messages, Cooperative Awareness Messages (CAMs) (e.g., defined by European Telecommunications Standards Institute (ETSI) European Standard (EN) 302 637-2) used by vehicles or other devices to share safety-based messages, Collective Perception Messages (CPMs) (e.g., defined by ETSI Technical Report (TR) 103 562 V2.1.1) used by vehicles or other devices to share safety-based messages, Decentralized Environmental Messages (DENM) (e.g., as defined by ETSI TR 102 698), messages according to SAE J2945/1 and/or ETSI EN 103 300, messages defined by China Society of Automotive Engineers (CSAE) and/or China—Intelligent Transportation Systems, and/or other types of messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. Cellular V2X (C-V2X) was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short-Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, VRU UEs such as pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs (also referred to herein as VRU UEs), and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Natural language processing (NLP) research has resulted in success in using large language models (LLMs) for many applications. For example, there are chatbots based on LLMs (such as ChatGPT) that can generate responses to queries based on the data on which the LLM was trained. LLMs have can simulate reasoning, perform mathematical calculations (using retrieval augmented methods), and use semantics to consume information and provide appropriate answers to queries.

However LLMs have no environmental awareness. For example, LLMs do not have sensors to obtain information about a current environment. Thus, an LLM can generate responses to queries based on the data on which the LLM was trained, but not based on live data.

Systems, apparatuses, methods (also referred to as processes), and computer-readable media (collectively referred to herein as “systems and techniques”) are described herein for generating responses to queries. For example, the systems and techniques described herein may obtain V2X messages, receive a query (e.g., from an occupant of a vehicle), and determine relevant V2X information based on the V2X messages. The systems and techniques may provide the query to an LLM and provide the relevant V2X information to an LLM (e.g., as context information). The LLM may generate a response to the query based on the query and the context information.

An LLM may be able to respond to queries based on the training of the LLM, for example, based on the data on which the LLM was trained. Additionally, an LLM may be provided with context information, for example, in addition to a query or as part of a query. The LLM may then be able to generate a response based on the context information and the data on which the LLM was trained. However, providing an LLM with too much context information and/or irrelevant context information may affect the ability of the LLM to generate an appropriate response.

Over an example period of time (e.g., 10 seconds) a vehicle (or a computing system of a vehicle) may receive several (e.g., dozens or hundreds) of V2X messages from various sources, including, for example, other vehicles, VRUs, RSUs, etc. Each of the V2X messages may include several fields, for example, fields including information such as, latitude, longitude, elevation, speed, heading, a timestamp, a messages count, an identifier, an indication of position accuracy, etc.

The systems and techniques may receive a query, for example, from an occupant (e.g., a driver, a passenger, a driver being assisted by an ADAS, or a driver acting as a backup to an ADAS). The systems and techniques may determine what information represented by the V2X messages is relevant to the query, for example, based on the query, based on the positions of the sources of the V2X messages, based on position and/or motion data of the vehicle, and/or based on timing of the V2X messages. The systems and techniques may filter the V2X messages to determine relevant V2X information. The systems and techniques may provide the relevant V2X information to an LLM and obtain a response to the query based on the relevant V2X information.

The systems and techniques may extend a safety sense of a user. For example, a user (e.g., an occupant of a vehicle) can leverage the systems and techniques (in addition to already-available perceptual and other sensor information) to understand the environment and/or make driving decisions.

It may be useful for driving systems (e.g., autonomous, semi-autonomous, or assisted driving systems, such as an advanced driver assistance system (ADAS)) of vehicles to be able to provide occupants (e.g., passengers or drivers) with responses to queries. These capabilities may important even for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous, semi-autonomous, or assisted driving systems are an example of where the systems and techniques described may be employed. Also, the systems and techniques described herein may be employed in non-autonomous (e.g., human controlled) vehicles. For example, the systems and techniques may provide responses to queries of a driver of a vehicle.

Various aspects of the application will be described with respect to the figures below.

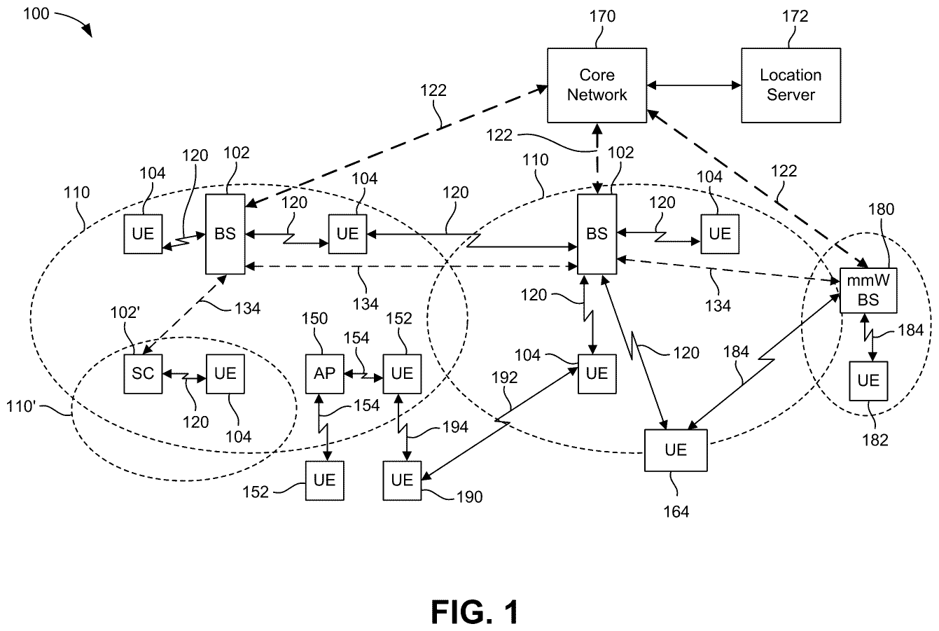

FIG. 1 illustrates an exemplary wireless communications system 100, according to various aspects. The wireless communications system 100 (which may also be referred to as a wireless wide area network (WWAN)) can include various base stations 102 and various UEs 104. In some aspects, the base station 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture and may include one or more of a central unit (CU), a distributed unit (DU), a radio unit (RU), a Near-Real Time (Near-RT) RAN Intelligent Controller (RIC), or a Non-Real Time (Non-RT) RIC. The base station 102 can include macro cell base stations (high power cellular base stations) and/or small cell base stations (low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base station 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base station 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base station 102 may communicate with each other directly or indirectly (e.g., through the EPC or 5GC) over backhaul links 134, which may be wired and/or wireless.

The base station 102 may wirelessly communicate with the UEs 104. Each of the base station 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro base stations 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the geographic coverage area 110 of one or more macro cell base station 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base station 102 and the UE 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STA) 152 via communication links 154 in an unlicensed frequency spectrum (e.g., 5 Gigahertz (GHz)). When communicating in an unlicensed frequency spectrum, the WLAN STAs 152 and/or the WLAN APs 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, WLAN APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) mmW base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base station 102/180, UE 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UE 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base station 102 may be an anchor carrier (or “PCell”) and other frequencies utilized by the macro cell base station 102 and/or the mmW base station 180 may be secondary carriers (“SCells”). In carrier aggregation, the base station 102 and/or the UE 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase ITS data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication links 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

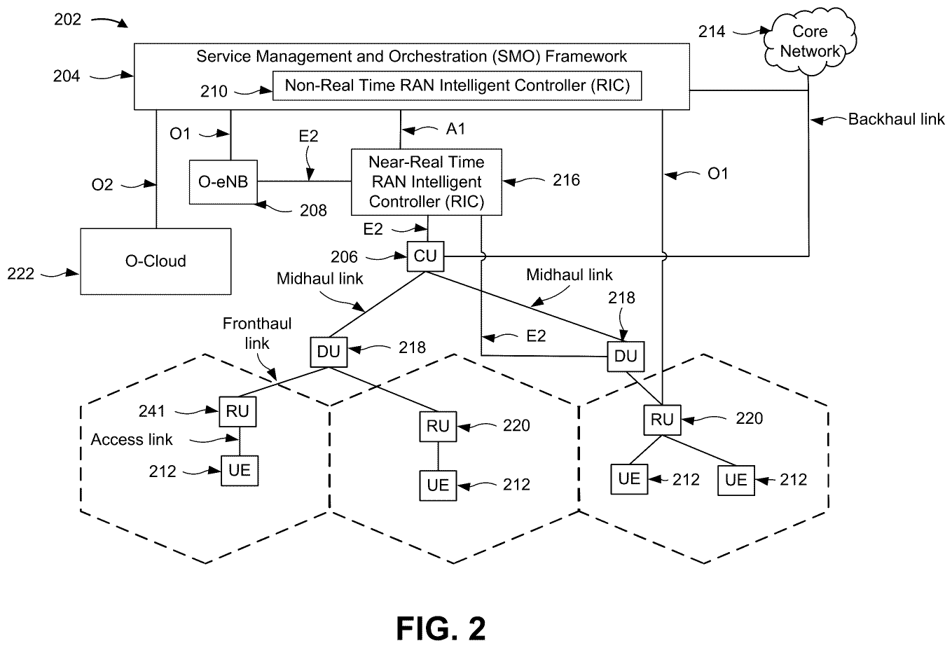

FIG. 2 is a diagram illustrating an example of a disaggregated base station architecture, which may be employed by the disclosed systems and methods for a robust and enhanced detection of position overlap of vehicles, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 202 architecture. The disaggregated base station 202 architecture may include one or more central units CUs 206 that can communicate directly with a core network 214 via a backhaul link, or indirectly with the core network 214 through one or more disaggregated base station units (such as a Near-Real Time (Near-RT) RAN Intelligent Controller 216 via an E2 link, or a Non-Real Time (Non-RT) 210 associated with a Service Management and Orchestration Framework (SMO Framework) 204, or both). A CU 206 may communicate with one or more distributed units DUs 218 via respective midhaul links, such as an F1 interface. The DUs 218 may communicate with one or more radio units RUs 220 via respective fronthaul links. The RUs 220 may communicate with respective UE 212 via one or more RF access links. In some implementations, the UE 212 may be simultaneously served by multiple RUs 220.

Each of the units, i.e., the CUs 206, the DUs 218, the RUs 220, as well as the Near-RT RICs 216, the Non-RT RICs 210 and the SMO Framework 204, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CUs 206 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 206. The CU 206 may be configured to handle user plane functionality (i.e., Central Unit-User Plane (CU-UP)), control plane functionality (i.e., Central Unit-Control Plane (CU-CP)), or a combination thereof. In some implementations, the CU 206 can be logically split into one or more CU-UP units and one or more CU-CP units. The CU-UP unit can communicate bidirectionally with the CU-CP unit via an interface, such as the E1 interface when implemented in an O-RAN configuration. The CU 206 can be implemented to communicate with the DU 218, as necessary, for network control and signaling.

The DU 218 may correspond to a logical unit that includes one or more base station functions to control the operation of one or more RUs 220. In some aspects, the DU 218 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 218 may further host one or more low PHY layers. Each layer (or module) can be implemented with an interface configured to communicate signals with other layers (and modules) hosted by the DU 218, or with the control functions hosted by the CU 206.

Lower-layer functionality can be implemented by one or more RUs 220. In some deployments, an RU 220, controlled by a DU 218, may correspond to a logical node that hosts RF processing functions, or low-PHY layer functions (such as performing fast Fourier transform (FFT), inverse FFT (iFFT), digital beamforming, physical random-access channel (PRACH) extraction and filtering, or the like), or both, based at least in part on the functional split, such as a lower layer functional split. In such an architecture, the RUs 220 can be implemented to handle over the air (OTA) communication with one or more UEs 212. In some implementations, real-time and non-real-time aspects of control and user plane communication with the RU 220 can be controlled by the corresponding DU 218. In some scenarios, this configuration can enable the DUs 218 and the CU 206 to be implemented in a cloud-based RAN architecture, such as a vRAN architecture.

The SMO Framework 204 may be configured to support RAN deployment and provisioning of non-virtualized and virtualized network elements. For non-virtualized network elements, the SMO Framework 204 may be configured to support the deployment of dedicated physical resources for RAN coverage requirements which may be managed via an operations and maintenance interface (such as an O1 interface). For virtualized network elements, the SMO Framework 204 may be configured to interact with a cloud computing platform (such as an open cloud (O-Cloud) 222) to perform network element life cycle management (such as to instantiate virtualized network elements) via a cloud computing platform interface (such as an O2 interface). Such virtualized network elements can include, but are not limited to, CUs 206, DUs 218, RUs 220 and Near-RT RIC 216. In some implementations, the SMO Framework 204 can communicate with a hardware aspect of a 4G RAN, such as an open eNB O-eNB 208, via an O1 interface. Additionally, in some implementations, the SMO Framework 204 can communicate directly with one or more RUs 220 via an O1 interface. The SMO Framework 204 also may include a Non-RT RIC 210 configured to support functionality of the SMO Framework 204.

The Non-RT RIC 210 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 210 may be coupled to or communicate with (such as via an A1 interface) the Near-RT RIC 216. The Near-RT RIC 216 may be configured to include a logical function that enables near-real-time control and optimization of RAN elements and resources via data collection and actions over an interface (such as via an E2 interface) connecting one or more CUs 206, one or more DUs 218, or both, as well as an O-eNB 208, with the Near-RT RIC 216.

In some implementations, to generate AI/ML models to be deployed in the Near-RT RIC 216, the Non-RT RIC 2107 may receive parameters or external enrichment information from external servers. Such information may be utilized by the Near-RT RIC 216 and may be received at the SMO Framework 204 or the Non-RT RIC 210 from non-network data sources or from network functions. In some examples, the Non-RT RIC 210 or the Near-RT RIC 216 may be configured to tune RAN behavior or performance. For example, the Non-RT RIC 210 may monitor long-term trends and patterns for performance and employ AI/ML models to perform corrective actions through the SMO Framework 204 (such as reconfiguration via O1) or via creation of RAN management policies (such as A1 policies).

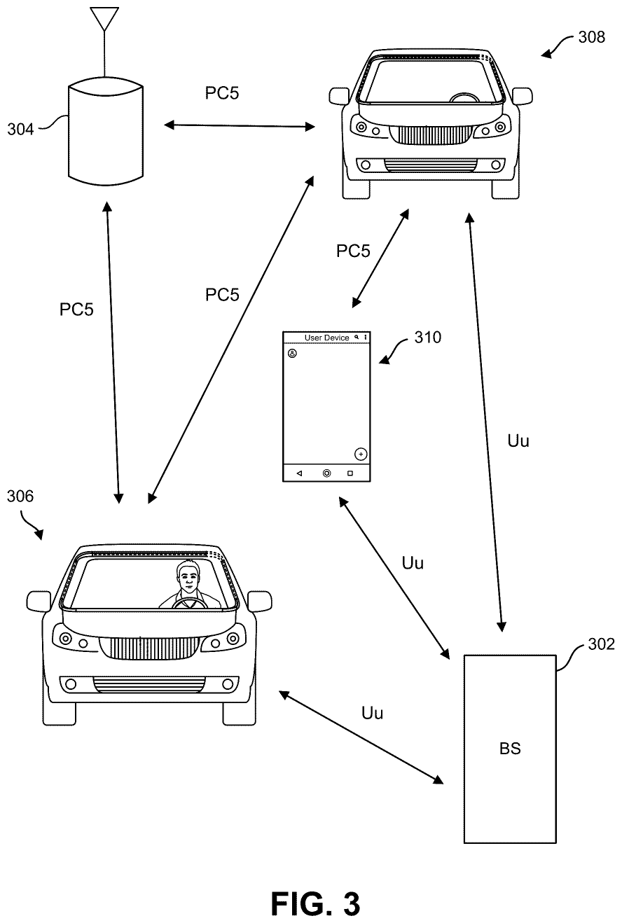

FIG. 3 illustrates examples of different communication mechanisms used by various UEs. In one example of sidelink communications, FIG. 3 illustrates a vehicle 306, a vehicle 308, and an RSU 304 communicating with each other using PC5, DSRC, or other device to device direct signaling interfaces. In addition, the vehicle 306 and the vehicle 308 may communicate with a BS 302 (shown as BS 302) using a network (Uu) interface. The BS 302 can include a gNB in some examples. FIG. 3 also illustrates a user device 310 communicating with the BS 302 using a network (Uu) interface. In one illustrative example, the user device 310 can communicate with vehicles (e.g., vehicle 308 and/or vehicle 308) over a PC5 interface (or other device to device direct interface, such as a DSRC interface), as shown in FIG. 3.

While FIG. 3 illustrates a particular number of vehicles (e.g., two vehicles 306 and 308) communicating with each other and/or with RSU 304, BS 302, and/or user device 310, the present disclosure is not limited thereto. For instance, tens or hundreds of such vehicles may be communicating with one another and/or with RSU 304, BS 302, and/or user device 310. At any given point in time, each such vehicle, RSU 304, BS 302, and/or user device 310 may transmit various types of information as messages to other nearby vehicles resulting in each vehicle (e.g., vehicles 306 and/or 308), RSU 304, BS 302, and/or user device 310 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSUs can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

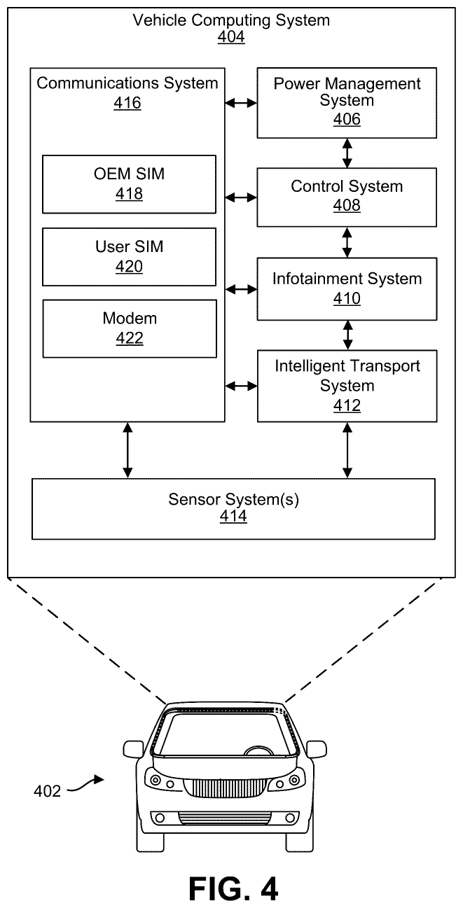

FIG. 4 is a block diagram illustrating an example a vehicle computing system 404 of a vehicle 402. The vehicle 402 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 404 can include at least a power management system 406, a control system 408, an infotainment system 410, an intelligent transport system (ITS) 412, one or more sensor system 414, and a communications system 416. In some cases, the vehicle computing system 404 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 408 can be configured to control one or more operations of the vehicle 402, the power management system 406, the vehicle computing system 404, the infotainment system 410, the intelligent transport system (ITS) 412, and/or one or more other systems of the vehicle 402 (e.g., a braking system, a steering system, a safety system other than the ITS 412, a cabin system, and/or other system). In some examples, the control system 408 can include one or more electronic control units (ECUs). An ECU can control one or more of the electrical systems or subsystems in a vehicle. Examples of specific ECUs that can be included as part of the control system 408 include an engine control module (ECM), a powertrain control module (PCM), a transmission control module (TCM), a brake control module (BCM), a central control module (CCM), a central timing module (CTM), among others. In some cases, the control system 408 can receive sensor signals from the one or more sensor systems 414 and can communicate with other systems of the vehicle computing system 404 to operate the vehicle 402.

The vehicle computing system 404 also includes a power management system 406. In some implementations, the power management system 406 can include a power management integrated circuit (PMIC), a standby battery, and/or other components. In some cases, other systems of the vehicle computing system 404 can include one or more PMICs, batteries, and/or other components. The power management system 406 can perform power management functions for the vehicle 402, such as managing a power supply for the vehicle computing system 404 and/or other parts of the vehicle. For example, the power management system 406 can provide a stable power supply in view of power fluctuations, such as based on starting an engine of the vehicle. In another example, the power management system 406 can perform thermal monitoring operations, such as by checking ambient and/or transistor junction temperatures. In another example, the power management system 406 can perform certain functions based on detecting a certain temperature level, such as causing a cooling system (e.g., one or more fans, an air conditioning system, etc.) to cool certain components of the vehicle computing system 404 (e.g., the control system 408, such as one or more ECUs), shutting down certain functionalities of the vehicle computing system 404 (e.g., limiting the infotainment system 410, such as by shutting off one or more displays, disconnecting from a wireless network, etc.), among other functions.

The vehicle computing system 404 further includes a communications system 416. The communications system 416 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 416 is configured to transmit and receive information wirelessly over any suitable wireless network (e.g., a 3G network, 4G network, 5G network, WiFi network, Bluetooth™ network, and/or other network). The communications system 416 includes various components or devices used to perform the wireless communication functionalities, including an original equipment manufacturer (OEM) subscriber identity module (referred to as a SIM or SIM OEM SIM 418, a user SIM 420, and a modem 422. While the vehicle computing system 404 is shown as having two SIMs and one modem, the vehicle computing system 404 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 418 can be used by the communications system 416 for establishing a wireless connection for vehicle-based operations, such as for conducting emergency-calling (eCall) functions, communicating with a communications system of the vehicle manufacturer (e.g., for software updates, etc.), among other operations. The OEM SIM 418 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 420 can be used by the communications system 416 for performing wireless network access functions in order to support a user data connection (e.g., for conducting phone calls, messaging, Infotainment related services, among others). In some cases, a user device of a user can connect with the vehicle computing system 404 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 416 the vehicle, in which case the user device can cease performance of the wireless network access functionality (e.g., during the period in which the communications system 416 is performing the wireless access functionality). The communications system 416 can begin interacting with a base station to perform one or more wireless communication operations, such as facilitating a phone call, transmitting and/or receiving data (e.g., messaging, video, audio, etc.), among other operations. In such cases, other components of the vehicle computing system 404 can be used to output data received by the communications system 416. For example, the infotainment system 410 (described below) can display video received by the communications system 416 on one or more displays and/or can output audio received by the communications system 416 using one or more speakers.

A modem is a device that modulates one or more carrier wave signals to encode digital information for transmission and demodulates signals to decode the transmitted information. The modem 422 (and/or one or more other modems of the communications system 416) can be used for communication of data for the OEM SIM 418 and/or the user SIM 420. In some examples, the modem 422 can include a 4G (or LTE) modem and another modem (not shown) of the communications system 416 can include a 5G (or NR) modem. In some examples, the communications system 416 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 422 (and/or one or more other modems of the communications system 416) can be used for performing V2X communications (e.g., with other vehicles for V2V communications, with other devices for D2D communications, with infrastructure systems for V2I communications, with pedestrian UEs for V2P communications, etc.). In some examples, the communications system 416 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 416 can be or can include a telematics control unit (TCU). In some implementations, the TCU can include a network access device (NAD) (also referred to in some cases as a network control unit or NCU). The NAD can include the modem 422, any other modem not shown in FIG. 4, the OEM SIM 418, the user SIM 420, and/or other components used for wireless communications. In some examples, the communications system 416 can include a Global Navigation Satellite System (GNSS). In some cases, the GNSS can be part of the one or more sensor systems 414, as described below. The GNSS can provide the ability for the vehicle computing system 404 to perform one or more location services, navigation services, and/or other services that can utilize GNSS functionality.

In some cases, the communications system 416 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 402 to communicate with a network and/or other UEs.

The vehicle computing system 404 can also include an infotainment system 410 that can control content and one or more output devices of the vehicle 402 that can be used to output the content. The infotainment system 410 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 402), and/or other output device.

In some examples, the vehicle computing system 404 can include the intelligent transport system (ITS) 412. In some examples, the ITS 412 can be used for implementing V2X communications. For example, an ITS stack of the ITS 412 can generate V2X messages based on information from an application layer of the ITS. In some cases, the application layer can determine whether certain conditions have been met for generating messages for use by the ITS 412 and/or for generating messages that are to be sent to other vehicles (for V2V communications), to pedestrian UEs (for V2P communications), and/or to infrastructure systems (for V2I communications). In some cases, the communications system 416 and/or the ITS 412 can obtain car access network (CAN) information (e.g., from other components of the vehicle via a CAN bus). In some examples, the communications system 416 (e.g., a TCU NAD) can obtain the CAN information via the CAN bus and can send the CAN information to a PHY/MAC layer of the ITS 412. The ITS 412 can provide the CAN information to the ITS stack of the ITS 412. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 412.

The conditions used to determine whether to generate messages can be determined using the CAN information based on safety-related applications and/or other applications, including applications related to road safety, traffic efficiency, infotainment, business, and/or other applications. In one illustrative example, the ITS 412 can perform lane change assistance or negotiation. For instance, using the CAN information, the ITS 412 can determine that a driver of the vehicle 402 is attempting to change lanes from a current lane to an adjacent lane (e.g., based on a blinker being activated, based on the user veering or steering into an adjacent lane, etc.). Based on determining the vehicle 402 is attempting to change lanes, the ITS 412 can determine a lane-change condition has been met that is associated with a message to be sent to other vehicles that are nearby the vehicle in the adjacent lane. The ITS 412 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 402, such as based on V2P communications with a UE of the user), traffic sign recognition, among others.

The ITS 412 can use any suitable protocol to generate messages (e.g., V2X messages). Examples of protocols that can be used by the ITS 412 include one or more Society of Automotive Engineering (SAE) standards, such as SAE J2735, SAE J2945, SAE J3161, SAE J2945/1, European Telecommunications Standards Institute (ETSI) European Standard (EN) 302 637-2, ETSI 103 562 V2.1.1, ETSI TR 102 698, ETSI EN 103 300, and/or other standards, which are hereby incorporated by reference in their entirety and for all purposes.

A security layer of the ITS 412 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 412 can be signed by the security layer of the ITS 412. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 412 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 408) to perform automatic functions, such as automatic breaking, automatic steering (e.g., to maintain a heading in a particular lane), automatic lane change negotiation with other vehicles, among other automatic functions. In one illustrative example, a message can be received by the communications system 416 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 408, which can cause the control system 408 to automatically break the vehicle 402 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 412 can receive a large number of messages from the other UEs (e.g., vehicles, RSUs, pedestrian user devices or VRU UEs, etc.), in which case the ITS 412 will authenticate (e.g., decode and decrypt) each of the messages and/or determine which operations to perform. Such a large number of messages can lead to a large computational load for the vehicle computing system 404. In some cases, the large computational load can cause a temperature of the vehicle computing system 404 to increase. Rising temperatures of the components of the vehicle computing system 404 can adversely affect the ability of the vehicle computing system 404 to process the large number of incoming messages. One or more functionalities can be transitioned from the vehicle 402 to another device (e.g., a user device, a RSU, etc.) based on a temperature of the vehicle computing system 404 (or component thereof) exceeding or approaching one or more thermal levels. Transitioning the one or more functionalities can reduce the computational load on the vehicle 402, helping to reduce the temperature of the components. A thermal load balancer can be provided that enable the vehicle computing system 404 to perform thermal based load balancing to control a processing load depending on the temperature of the vehicle computing system 404 and processing capacity of the vehicle computing system 404.

The vehicle computing system 404 further includes one or more sensor systems 414 (e.g., a first sensor system through an Nth sensor system, where N is a value equal to or greater than 0). When including multiple sensor systems, the sensor systems 414 can include different types of sensor systems that can be arranged on or in different parts the vehicle 402. The sensor systems 414 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the vehicle computing system 404 of the vehicle 402.

While the vehicle computing system 404 is shown to include certain components and/or systems, one of ordinary skill will appreciate that the vehicle computing system 404 can include more or fewer components than those shown in FIG. 4. For example, the vehicle computing system 404 can also include one or more input devices and one or more output devices (not shown). In some implementations, the vehicle computing system 404 can also include (e.g., as part of or separate from the control system 408, the infotainment system 410, the communications system 416, and/or the sensor systems 414) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

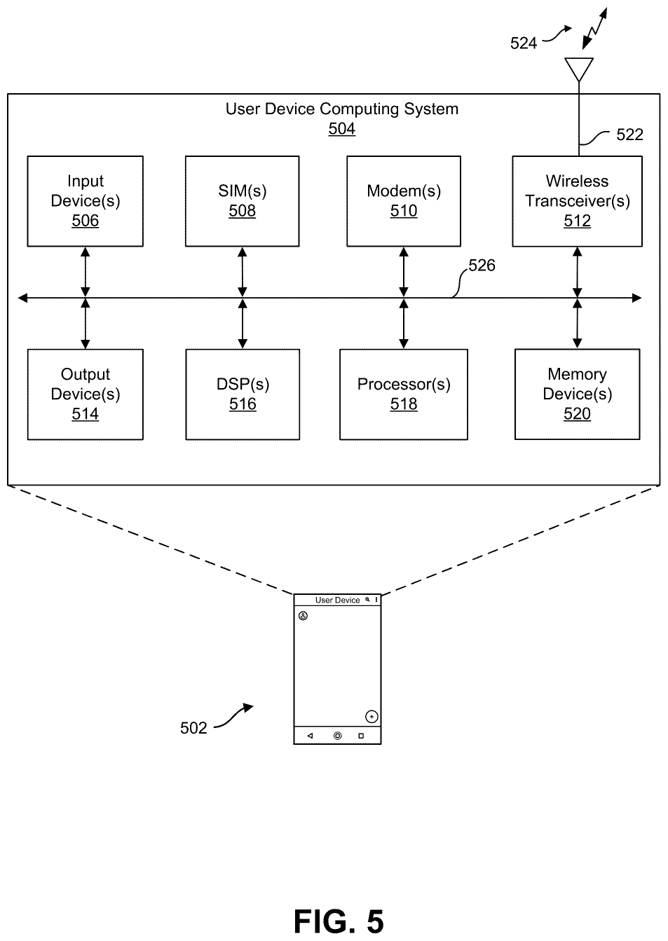

FIG. 5 illustrates an example of a user device computing system 504 of a user device 502. The user device 502 is an example of a UE that can be used by an end-user. For example, the user device 502 can include a mobile phone, router, tablet computer, laptop computer, tracking device, wearable device (e.g., a smart watch, glasses, an XR device, etc.), Internet of Things (IoT) device, and/or another device used by a user to communicate over a wireless communications network. The user device computing system 504 includes software and hardware components that can be electrically or communicatively coupled via a bus 526 (or may otherwise be in communication, as appropriate). For example, the user device computing system 504 includes one or more processors 518. The one or more processors 518 can include one or more CPUs, ASICs, FPGAs, Aps, GPUs, VPUs, NSPs, microcontrollers, dedicated hardware, any combination thereof, and/or other processing device or system. The bus 526 can be used by the one or more processors 518 to communicate between cores and/or with the one or more memory devices 520.

The user device computing system 504 may also include one or more memory devices 520, one or more digital signal processors DSPs 516, one or more SIMs 508, one or more modems 510, one or more wireless transceivers 512, an antenna 522, one or more input devices 506 (e.g., a camera, a mouse, a keyboard, a touch sensitive screen, a touch pad, a keypad, a microphone, and/or the like), and one or more output devices 514 (e.g., a display, a speaker, a printer, and/or the like).

The one or more wireless transceivers 512 can receive wireless signals (e.g., wireless signal 524) via antenna 522 from one or more other devices, such as other user devices, vehicles (e.g., vehicle 402 of FIG. 4 described above), network devices (e.g., base stations such as eNBs and/or gNBs, WiFi routers, etc.), cloud networks, and/or the like. In some examples, the user device computing system 504 can include multiple antennae. The wireless signal 524 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 512 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 524 into a baseband or intermediate frequency and can convert the RF signals to the digital domain.

In some cases, the user device computing system 504 can include a coding-decoding device (or CODEC) configured to encode and/or decode data transmitted and/or received using the one or more wireless transceivers 512. In some cases, the user device computing system 504 can include an encryption-decryption device or component configured to encrypt and/or decrypt data (e.g., according to the AES and/or DES standard) transmitted and/or received by the one or more wireless transceivers 512.

The one or more SIMs 508 can each securely store an IMSI number and related key assigned to the user of the user device 502. As noted above, the IMSI and key can be used to identify and authenticate the subscriber when accessing a network provided by a network service provider or operator associated with the one or more SIMs 508. The one or more modems 510 can modulate one or more signals to encode information for transmission using the one or more wireless transceivers 512. The one or more modems 510 can also demodulate signals received by the one or more wireless transceivers 512 in order to decode the transmitted information. In some examples, the one or more modems 510 can include a 4G (or LTE) modem, a 5G (or NR) modem, a modem configured for V2X communications, and/or other types of modems. The one or more modems 510 and the one or more wireless transceivers 512 can be used for communicating data for the one or more SIMs 508.

The user device computing system 504 can also include (and/or be in communication with) one or more non-transitory machine-readable storage media or storage devices (e.g., one or more memory devices 520), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory devices 520 and executed by the one or more processors 518 and/or the one or more DSPs 516. The user device computing system 504 can also include software elements (e.g., located within the one or more memory devices 520), including, for example, an operating system, device drivers, executable libraries, and/or other code, such as one or more application programs, which may comprise computer programs implementing the functions provided by various aspects, and/or may be designed to implement methods and/or configure systems, as described herein.

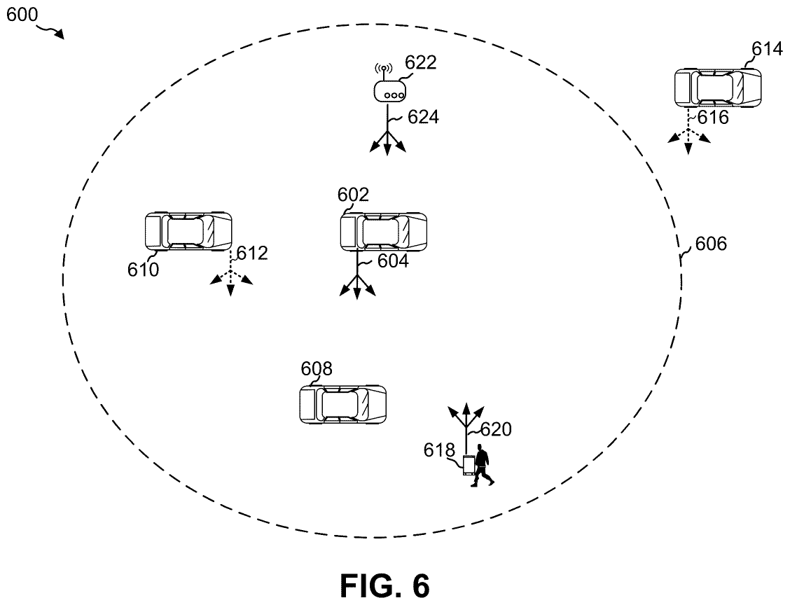

FIG. 6 illustrates an example 600 of wireless communication between devices based on sidelink communication, such as V2X or other D2D communication. The communication may be based on a slot structure. For example, transmitting UE 602 may transmit a transmission 604, (e.g., comprising a control channel and/or a corresponding data channel), that may be received by UEs 608, 610, 614, 618 and/or RSU 622. At least one UE may comprise an autonomous vehicle or an unmanned aerial vehicle. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The UEs 602, 608, 610, 614, and/or 618 and RSU 622 may each be capable of operating as a transmitting device in addition to operating as a receiving device. Thus, UEs 610, 614 and 618 and RSU 622 are illustrated as transmitting transmissions 612, 616, 620, and 624, respectively. The transmissions 604, 612, 620, and 616 may be broadcast or multicast to nearby devices. For example, UE 602 may transmit communication intended for receipt by other UEs within a range 606 of UE 602. Additionally or alternatively, RSU 622 may receive communication from and/or transmit transmission 624 to UE 602, 608, 610, 614 and/or 618. UEs 602, 608, 610, 614, 618 and/or RSU 622 may comprise respective detection components. UEs 602, 608, 610, 614, 618 and/or RSU 622 may also comprise a BSM or mitigation component.

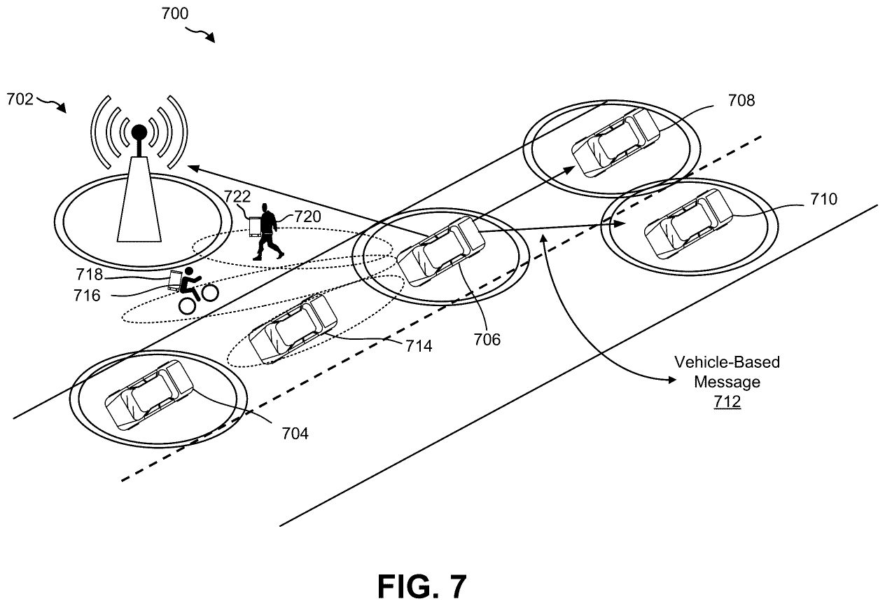

FIG. 7 is a diagram illustrating an example of a system 700 for sensor sharing (which may alternatively be referred to as “collective perception”) in wireless communications (e.g., C-V2X communications), in accordance with some aspects of the present disclosure. In FIG. 7, the system 700 is shown to include a plurality of equipped (e.g., V2X capable) network devices. The plurality of equipped network devices includes vehicles (e.g., automobiles) 704, 706, 708, 710, an RSU 702, a VRU UE 718 of a cyclist 716 and VRU UE 722 of a pedestrian 720. Also shown are a plurality of non-equipped devices, which include a non-equipped vehicle 714. The system 700 may comprise more or fewer equipped network devices and/or more or fewer non-equipped network devices, than as shown in FIG. 7. In addition, the system 700 may comprise more or fewer different types of equipped network devices (e.g., which may include equipped UEs) and/or more or fewer different types of non-equipped network devices (e.g., which may include non-equipped UEs) than as shown in FIG. 7. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices (e.g., vehicles 704, 706, 708, 710, RSU 702, VRU UE 718, and/or VRU UE 722) may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In addition, at least some of the equipped network devices may be configured to perform sidelink positioning (e.g., as described by 3^{rd} Generation partnership project (3GPP) Release 18) to determine absolute location, relative location, and/or motion states of surrounding UEs. In one or more examples, vehicles 704, 706, 708, 710 RSU 702, VRU UE 718, and/or VRU UE 722 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 700. For example, vehicle 706 may be a luxury vehicle and, as such, have more expensive, higher capability sensors than other vehicles that are economy vehicles. In one illustrative example, vehicle 706 may have one or more higher capability LIDAR sensors (e.g., high capability optical lasers and optical sensors) than the other equipped network devices in the system 700. In one illustrative example, a LIDAR of vehicle 706 may be able to detect the cyclist 716 and/or a pedestrian 720 with a large degree of confidence (e.g., a seventy percent degree of confidence). In another example, vehicle 706 may have higher capability radar (e.g., high capability RF antennas) than the other equipped network devices in the system 700. For instance, the radar of vehicle 706 may be able to detect the cyclist 716 and/or pedestrian 720 with a degree of confidence (e.g., an eight-five percent degree of confidence). In another example, vehicle 706 may have higher capability camera (e.g., with higher resolution capabilities, higher frame rate capabilities, better lens, etc.) than the other equipped network devices in the system 700.

During operation of the system 700, the equipped network devices (e.g., vehicles 704, 706, 708, 710, RSU 702, VRU UE 718, and/or VRU UE 722) may generate at least one vehicle-based message 712 (e.g., a C-V2X message, such as a Sensor Data Sharing Message (SDSM), a Basic Safety Message (BSM), a Cooperative Awareness Message (CAM), a Collective Perception Messages (CPM), a Decentralized Environmental Message (DENM), and/or other type of message). In some implementations, the vehicle-based message 712 may include a specific use case or safety warning, such as a do-not-pass warning (DNPW) or a forward collision warning (FCW), related to the current conditions of the equipped network device (e.g., vehicles 704, 706, 708, 710). In some examples, the vehicle-based message 712 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), a Decentralized Environmental Message (DENM), and/or other format.

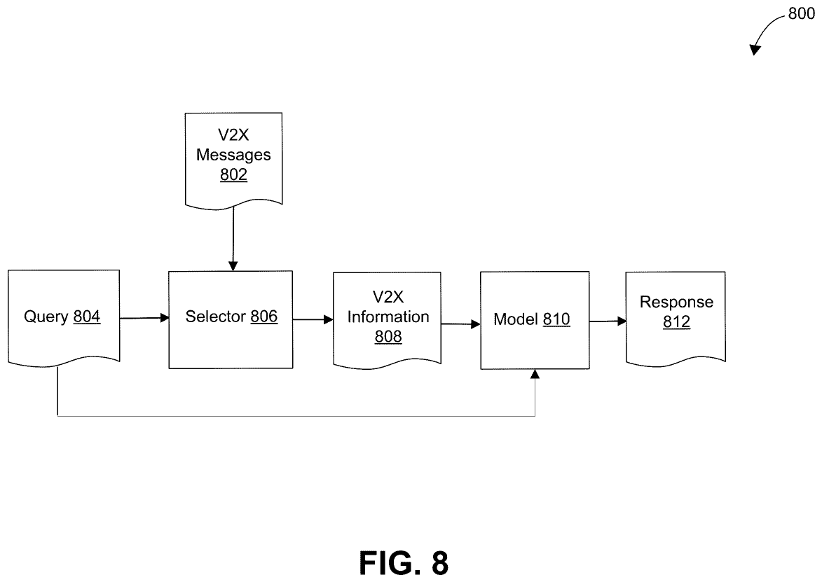

FIG. 8 is a block diagram illustrating an example system 800 for generating a response 812 to a query 804, according to various aspects of the present disclosure. For example, an occupant of a vehicle may pose query 804. The vehicle, or a computing system thereof, may obtain V2X messages 802. Selector 806 of the vehicle (or of the computing system of the vehicle) may determine relevant V2X information 808 (e.g., a subset of V2X messages 802). The vehicle (or of the computing system of the vehicle) may provide query 804 to machine-learning model 810 (e.g., a large language model (LLM)). The vehicle (or of the computing system of the vehicle) may additionally provide relevant V2X information 808 as context information to machine-learning model 810. Machine-learning model 810 may generate response 812 based on query 804 and relevant V2X information 808.

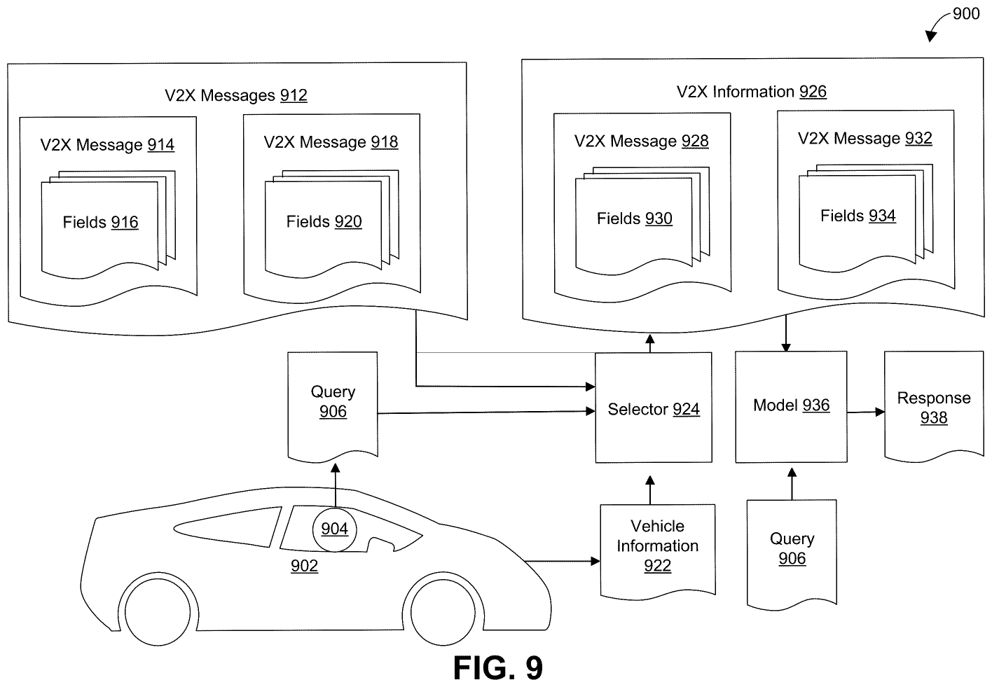

FIG. 9 is a block diagram illustrating an example system 900 for generating a response 938 to a query 906, according to various aspects of the present disclosure. For example, an occupant 904 of a vehicle 902 may pose query 906. Vehicle 902, or a computing system thereof, may obtain V2X messages 912. Selector 924 of vehicle 902 (or of the computing system of vehicle 902) may determine relevant V2X information 926 (e.g., a subset of V2X messages 912). Vehicle 902 (or of the computing system of vehicle 902) may provide query 906 to machine-learning model 936 (e.g., a large language model (LLM)). Vehicle 902 (or of the computing system of vehicle 902) may additionally provide relevant V2X information 926 as context information to machine-learning model 936. Machine-learning model 936 may generate response 938 based on query 906 and relevant V2X information 926.

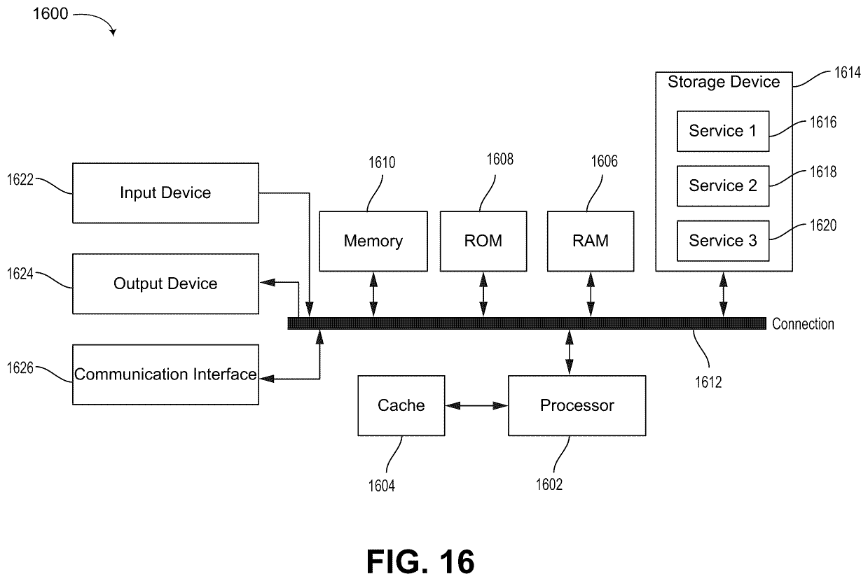

Vehicle 902 may be any suitable vehicle that includes a computing system, such as computing-device architecture 1600 of FIG. 16. In the present disclosure, references to vehicle 902 may include references to components of vehicle 902. For example, vehicle 902 may receive V2X messages 912 using a communication component of vehicle 902. As another example, vehicle 902 may obtain query 906 at a user interface (e.g., including a microphone or touchscreen) of vehicle 902. As another example, vehicle 902 may implement selector 924 and machine-learning model 936 at one or more processors of vehicle 902.

Occupant 904 may be a person associated with vehicle 902. Occupant 904 may be in vehicle 902, for example, occupant 904 may be a passenger in vehicle 902. Alternatively, occupant 904 may be a driver of vehicle 902, according to any level of automation of vehicle 902.

Query 906 may be a query from occupant 904. Query 906 may be spoken, recorded by a microphone of vehicle 902, and translated into text or computer-interpretable language by vehicle 902. Alternatively, query 906 may be provided by occupant 904 through some other means, for example, a touch screen or keypad. Query 906 may relate to an environment of vehicle 902, a plan of vehicle 902, and/or upcoming or past driving maneuvers of vehicle 902. For example, query 906 may relate to whether it is safe, or advisable to change lanes, take a certain route, avoid a certain route or road, speed up, or slow down. For example, occupant 904 may speak aloud “is it safe to change lanes?” “can I avoid traffic by taking Falcon Way?” or “am I following too closely?”

V2X messages 912 may be, or may include, a number of V2X messages received from a number of sources over a period of time. For example, V2X messages 912 may include V2X messages, such as basic safety messages (BSMs) (e.g., from other vehicles), personal safety messages (PSMs) (e.g., from vulnerable road users (VRUs) such as pedestrians or cyclists), or cooperative awareness messages (CAMs). V2X messages 912 may include V2X messages from any number and/or types of sources including, for example, other vehicles, roadside units (RSUs), VRUs. As an example, V2X messages 912 is illustrated as including V2X message 914, which may be from a first source, such as a first vehicle, and V2X message 918, which may be from a second source, such as a second vehicle. V2X messages 912 may be received via sidelink communications and/or via a base station.

V2X messages 912 may represent all V2X messages received by vehicle 902 since vehicle 902 was turned on or began driving. Alternatively, V2X messages 912 may represent a subset of all V2X messages, such as the most recent 60 seconds of V2X messages received. As an example, V2X messages 912 may represent the most-recently-received V2X message from each respective source of V2X messages. For example, V2X message 914 may represent a most-recently receive V2X message from a first vehicle and V2X message 918 may represent a most-recently receive V2X message from a second vehicle. Vehicle 902 may receive V2X messages 912 (e.g., using a communication component) and store V2X messages 912 in a memory of vehicle 902.

Each of V2X messages 912 may include values for various fields. For example, V2X messages 912, as received and/or stored, may follow a format for storing values associated with fields. Table 1 provides an example of fields that may be included in V2X messages 912. For example, each of V2X messages 912 may include values corresponding to at least some of the fields of Table 1.

TABLE 1

| | | Size |
|---|---|---|
| Type | Description | (byte) |
| DSRCmsgID | Data elements used in each message to define the | 1 |
| | Message type. | |
| MsgCount | It can check the flow of consecutive messages | 1 |
| | having the same DSRCmsgID received from the | |
| | same message sender. | |
| TemporaryID | Represents a 4-byte temporary device identifier. | 4 |
| | When used in a mobile OBU device, this value is | |
| | periodically changed to ensure anonymity. | |
| Dsecond | Represents two bytes of time information. | 2 |
| Latitude | Represents the geographic latitude of an object. | 4 |
| Longitude | Represents the geographic longitude of an object. | 4 |
| Elevation | Represents an altitude measured by the WGS84 | 2 |
| | coordinate system. | |
| PositionAccuracy | Various quality parameters used to model the | 4 |
| | positioning accuracy for each given axis. | |
| TransmissionAndSpeed | Represents the speed of the vehicle. | 2 |
| Heading | The current direction value is expressed in units of | 2 |
| | 0.0125 degrees. | |
| SteeringWheelAngle | Represents the current steering angle of the steering | 1 |
| | wheel. | |
| AccelerationSet4Way | It consists of three orthogonal directions of | 7 |
| | acceleration and yaw rate. | |
| BrakeSystemStatus | Represents a data element that records various | 2 |
| | control states related to braking of the vehicle. | |
| VehicleSize | Represents the length and width of the vehicle. | 3 |

V2X messages 912 may include V2X messages including data values for different fields and/or different numbers of fields. For example, V2X message 914 may be from a vehicle and may include fields 916 including a first number of fields. V2X message 918 may be from a VRU and may include fields 920 including a second number of fields that is fewer than the first number of fields. For example, V2X message 918 may not include a field for transmission and speed and brake system status.

Vehicle 902 may determine vehicle information 922 which may include data related to vehicle 902. For example, vehicle information 922 may include information indicating: a location of vehicle 902, a speed of vehicle 902, a heading of vehicle 902, a destination of vehicle 902, a route planned for vehicle 902, a transmission setting of vehicle 902, a brake status of vehicle 902, a size of vehicle 902, a weight of vehicle 902, etc.

Selector 924 may be, or may include, a process or module implemented by vehicle 902 (or by a computing system of vehicle 902). Selector 924 may determine relevant V2X information 926. Selector 924 may determine relevant V2X information 926 such that relevant V2X information 926 is a subset of V2X messages 912. Selector 924 may determine relevant V2X information 926 based on query 906 and/or vehicle information 922.

In some aspects, selector 924 may select relevant fields of V2X messages 912. For example, selector 924 may determine which fields of V2X messages 912 are relevant for responding to query 906. For instance, selector 924 may determine that for V2X message 914, which includes fields 916, fields 930 are relevant. Further, selector 924 may generate V2X message 928 based on V2X message 914, where V2X message 928 includes fields 930, which are the relevant fields of fields 916 of V2X message 914. As an example, selector 924 may determine that, for an example query 906 (such as, “is it safe to turn right now?”), fields related to position and speed are relevant. Thus, for all V2X messages 912, selector 924 may select the relevant fields for inclusion in relevant V2X information 926.

Additionally or alternatively, selector 924 may select relevant V2X messages from among V2X messages 912 based on a source of the V2X messages. For example, selector 924 may select V2X message 928 and V2X message 932 from among V2X messages 912 based on a source of V2X message 928 and a source of V2X message 932 being within a distance threshold from vehicle 902 and/or travelling faster than a threshold speed. Additionally, selector 924 may not select others of V2X messages 912 based on the sources of the others of V2X messages 912 being outside the distance threshold from vehicle 902 and travelling below the threshold speed.

Additionally or alternatively, selector 924 may select relevant V2X messages from among V2X messages 912 based on timing. For example, selector 924 may select a most recent V2X message from each source. Additionally or alternatively, selector 924 may select V2X messages that were received, or have a timestamp, within a threshold time duration, such as 5 seconds.

In some aspects, selector 924 may operate according to predefined rules and/or logic. For example, selector 924 may operate according to a number of thresholds. For example, for an immediate-action query (such as a query regarding turning or changing lanes immediately, or within 10 seconds), selector 924 may include rules defining a distance thresholds and/or speed thresholds for sources of V2X messages 912 to include in relevant V2X information 926.

In some aspects, selector 924 may be, or may include, a machine-learning model (such as a transformer or sentence transformer). The machine-learning model may be trained, for example, according to a supervised contrastive-learning approach, to determine relevant V2X information 926 from among V2X messages 912 based on query 906 and/or vehicle information 922. For example, selector 924 may be provided with a training query and corresponding training relevant V2X information (e.g., Fᵣₑₗ) and training irrelevant V2X information (Fᵢᵣᵣ). Table 2 provides an example of training data.

TABLE 2

| Query | Fᵣₑₗ | Fᵢᵣᵣ |
|---|---|---|
| Can I turn left now? | type of message; | message count; |
| | speed; | elevation |
| | heading | |
| Is this a safe following | type of message; | message count; |
| distance? | latitude; | brake system status |
| | longitude | |

In the training process, selector 924 may predict provisional relevant V2X information. A trainer may compare the predicted provisional relevant V2X information to the training relevant V2X information and the training irrelevant V2X information. The trainer may determine a loss based on differences between the predicted provisional relevant V2X information and the training relevant V2X information. Further, the trainer may determine the loss based on similarities between the predicted provisional relevant V2X information and the training irrelevant V2X information. The trainer may then adjust parameters (e.g., weights) of selector 924 based on the loss (e.g., according to a gradient-descent technique) such that in future iterations of the training process, the predicted relevant V2X information is more similar to the training relevant V2X information and less similar to the training irrelevant V2X information. Once trained, the machine-learning model of selector 924 may be deployed in vehicle 902 and may be used to predict relevant V2X information 926 based on V2X messages 912, query 906, and/or vehicle information 922.

In some aspects, selector 924 may be trained to prioritize some V2X messages over others. For example, selector 924 may be trained to prioritize messages from VRUs (e.g., PSMs) over messages from vehicles (e.g., BSMs) and/or messages from vehicles over messages from RSUs. For example, selector 924 may be more likely to select (for inclusion in relevant V2X information 926) V2X messages 912 from VRUs than V2X messages 912 from vehicles.

Relevant V2X information 926 may be a subset of V2X messages 912, for example, as selected by selector 924. For example, relevant V2X information 926 may include V2X messages from fewer sources than the sources from which V2X messages 912 includes V2X messages. As an example, relevant V2X information 926 may include fewer V2X messages than V2X messages 912 includes based on a timing of the V2X messages. For example, V2X messages 912 may include all V2X messages received within the last 60 seconds while relevant V2X information 926 may include only V2X messages received within the last 5 seconds. Additionally or alternatively, V2X messages of relevant V2X information 926 may include fewer fields than the number of fields included by V2X message messages of V2X messages 912.

In some aspects, selector 924 may reduce the number of fields of relevant V2X information 926, compared with the number of fields of V2X messages 912. In some cases, selector 924 may select a number of fields that are most relevant to query 906. For example, selector 924 may select the three fields that are most relevant to query 906 for inclusion in relevant V2X information 926. For instance, V2X message 914 may include values for ten fields 916. Selector 924 may select the three fields 916 with the highest relevance score (with relation to query 906) for inclusion in relevant V2X information 926 as fields 930 of V2X message 928. In some cases, selector 924 may select all fields that have a relevance (with relation to query 906) above a threshold for inclusion in relevant V2X information 926. For example, selector 924 may determine that to include (in relevant V2X information 926) all fields of fields 916 that have a Cosine distance that is less than a threshold.

In some aspects, selector 924 may select the same fields for all sources of V2X messages 912. For example, selector 924 may determine that location information (e.g., latitude and longitude) of all sources of V2X messages 912 are relevant to query 906. In some aspects, selector 924 may select fields on a per-source basis. For example, selector 924 may determine that speed information is relevant to query 906 for vehicles but not for VRUs.

In some aspects, selector 924 may retain certain fields as a rule. For example, selector 924 may select, by rule, fields including: message type (which may indicate the type of source of the V2X message such as, vehicle (including vehicle type), VRU (whether on the road, biking, etc.), or RSU), current location of the source of the V2X message, heading of the source of the V2X message, and speed of the source of the V2X message. Additionally or alternatively, selector 924 may retain, by rule, fields including position accuracy. In some aspects, selector 924 may retain position accuracy so that machine-learning model 936 may determine a confidence level of response 938. For example, if the position accuracy reported by V2X message 914 is low, machine-learning model 936 may indicate, in response 938, that response 938 is unreliable relative to the source of V2X message 914 due to high position errors reported by the source of V2X message 914.

In some aspects, system 900 may determine information for relevant V2X information 926 based on V2X messages 912. For example, selector 924 of system 900, or another component of system 900, may determine a distance between vehicle 902 and a source of a V2X message of V2X messages 912, for example, based on the position of vehicle 902 (as reported in vehicle information 922) and based on position data of the V2X message of V2X messages 912. As another example, system 900 may determine a time to collision between vehicle 902 and a source of a V2X message of V2X messages 912 based on the current speed, heading, and location of vehicle 902 and of the source of the V2X message. System 900 may include the distance and/or the time to collision in relevant V2X information 926.

Machine-learning model 936 may be, or may include, a process or module implemented by vehicle 902 (or by a computing system of vehicle 902). Machine-learning model 936 may be, or may include, a large language model (LLM). Machine-learning model 936 may be trained using a large training corpus (including, for example, petabytes of data). Machine-learning model 936 may be trained to perform general language tasks, such as, for example, answering questions, summarizing documents, and/or text generation.

In some aspects, machine-learning model 936 may be finetuned for responding to queries based on relevant V2X information 926. For example, machine-learning model 936 may be additionally trained using training V2X messages (e.g., BSMs, PSMs, and/or CAMs) as training data. Additionally or alternatively, machine-learning model 936 may be trained using in-context examples.

For example, in the training process, relevant V2X information 926 may be provided with a training query and training relevant V2X messages (the relevant V2X messages may be provided as context information). Relevant V2X information 926 may generate a provisional response to the training query. A trainer may obtain a ground-truth response to the training query. The ground-truth response may be based on the scenario reflected by the V2X messages. The training ground-truth responses may include reasoning supporting the response. For example, a scenario may be simulated. V2X messages based on the simulated scenario may be generated. The V2X messages may reflect the scenario, for example, indicating locations and/or speeds of vehicles, VRUs, and/or RSUs. Training queries and corresponding ground-truth responses may be generated based on the scenario. For example, for an ego vehicle, a training query may be “can I turn right now?” According to the scenario, another vehicles may be approaching the ego vehicle from behind (e.g., in a blind spot of the driver of the ego vehicle). The ground-truth response to the query may include “no.” Further the ground-truth response may include “because there is a car approaching from behind you, on your right side.”

The trainer may compare the provisional response generated by machine-learning model 936 with the ground-truth response and determine a loss based on a difference between the provisional response and the ground truth response. The trainer may adjust machine-learning model 936 based on the loss such that in future iterations of the iterative training process, provisional responses generated by machine-learning model 936 are more similar to the ground-truth response. By fine-tuning machine-learning model 936 using ground-truth responses including reasoning, the trainer may train machine-learning model 936 how to respond and what information of the context information (e.g., the training V2X messages) is relevant to the response.

In some aspects, while machine-learning model 936 is being fine-tuned (and/or trained), a set of rules may be instilled into machine-learning model 936 to enhance the likelihood of a correct response. For example, for queries relating to a class of source of V2X message (e.g., vehicles, VRUs, or RSUs), machine-learning model 936 may be fine-tuned to respond based on V2X messages from sources matching the class. For instance, for a query relating to pedestrians (such as “are there any pedestrians approaching the upcoming intersection”), machine-learning model 936 may be trained to use V2X messages from only pedestrians.

As another example, machine-learning model 936 may be fine-tuned to respond to queries based on locations of sources of V2X messages. For example, for machine-learning model 936 may be fine-tuned to respond to queries based on V2X messages received from sources that are within a threshold distance from vehicle 902.

In some cases, calculations to be performed (e.g., to determine distances between vehicle 902 and sources of V2X messages 912) can be performed using retrieval augmented techniques (e.g., invoking math calculations). Additionally or alternatively, calculations can be performed with other tools and provided to the LLM. For example, machine-learning model 936 may invoke calculators when machine-learning model 936 encounters math operations in a sentence. Additionally or alternatively, machine-learning model 936 may invoke a global positioning system (GPS) converter to convert latitude and longitude to a location or vice versa.

In some aspects, machine-learning model 936 may be trained using in-context examples. For example, an example query may be “it's getting dark. Are there any pedestrians or parked vehicles on the roadside that I need to watch out for?” Inputs to machine-learning model 936 may include V2X messages from all sources filtered by pedestrians and vehicles that are within a preset distance from vehicle 902. For example, the set of pedestrians whose heading (inferred from the reported heading field in V2X messages 912) is approaching vehicle 902 may be determined. Additionally or alternatively, the vehicles whose speed (inferred from the speed field in V2X messages 912) is zero or close to zero (e.g., which may indicate that the vehicles are parked) may be identified. The ground-truth response may include the number of pedestrians and vehicles that satisfy the query. Additionally or alternatively, if the position/speed/heading accuracy of any of the sources of V2X messages is higher than a threshold, the ground-truth response may also indicate a degree of uncertainty. Machine-learning model 936 may be fine-tuned based on the in-context example.

In some aspects, machine-learning model 936 may generate confidence data related to response 938. For example, machine-learning model 936 may, based confidence data of V2X messages 912, determine a confidence associated with response 938 and provide the response with response 938.

Once trained, machine-learning model 936 may be deployed, for example, in vehicle 902 and used to predict responses to queries provided by occupant 904 of vehicle 902.

Vehicle 902 may provide query 906 to machine-learning model 936 as a query. Additionally, vehicle 902 may provide relevant V2X information 926 to machine-learning model 936 as context information. Machine-learning model 936 may generate response 938 based on query 906 and relevant V2X information 926. For example, machine-learning model 936 may be trained to accept context information and to use the context information when responding to queries.

Vehicle 902 may provide response 938 to occupant 904 using any suitable means. For example, in some aspects, vehicle 902 may vocalize and output response 938 (e.g., using a vocalization model and speakers of 902). As an example, vehicle 902 may display response 938 using a heads-up display (HUD) (e.g., on a windshield of vehicle 902).

By using relevant V2X information 926, machine-learning model 936 may be capable of responding to query 906 when query 906 relates to a current situation of vehicle 902, even though machine-learning model 936 was not trained based on the current situation of vehicle 902. In this way, machine-learning model 936 may be used to respond to queries based on situational awareness.

Additionally or alternatively, system 900 may summarize V2X messages 912. In some cases, the summary may be provided to occupant 904, for example, as a response 938 to query 906. For example, system 900 may generate a summary of V2X messages 912 received by vehicle 902 over a sliding time window. Further, the summary may be based on vehicle 902 as center of reference. For example, the summary may include information based on V2X messages 912 from sources that are within a threshold distance from vehicle 902. For instance, the summary may be based on V2X messages 912 from sources within 20 meters of vehicle 902. Additionally or alternatively, in the summary, information may be ordered based proximity to vehicle 902. For example, the summary may describe a source of V2X messages closes to vehicle 902 first, and sources farther from vehicle 902 in sequential order based on respective distances from vehicle 902.

In some aspects, system 900 may generate and/or provide the summary without being prompted by a query 906, for example, at regular intervals or based on a change in V2X messages 912, for example, a change in the number of sources from which V2X messages 912 are received. Additionally or alternatively, system 900 may generate and/or provide the summary if system 900 is unsure of query 906 or unsure of an appropriate response to query 906. For example, if system 900 does not understand query 906, system 900 may offer the summary in place of a direct response to query 906.

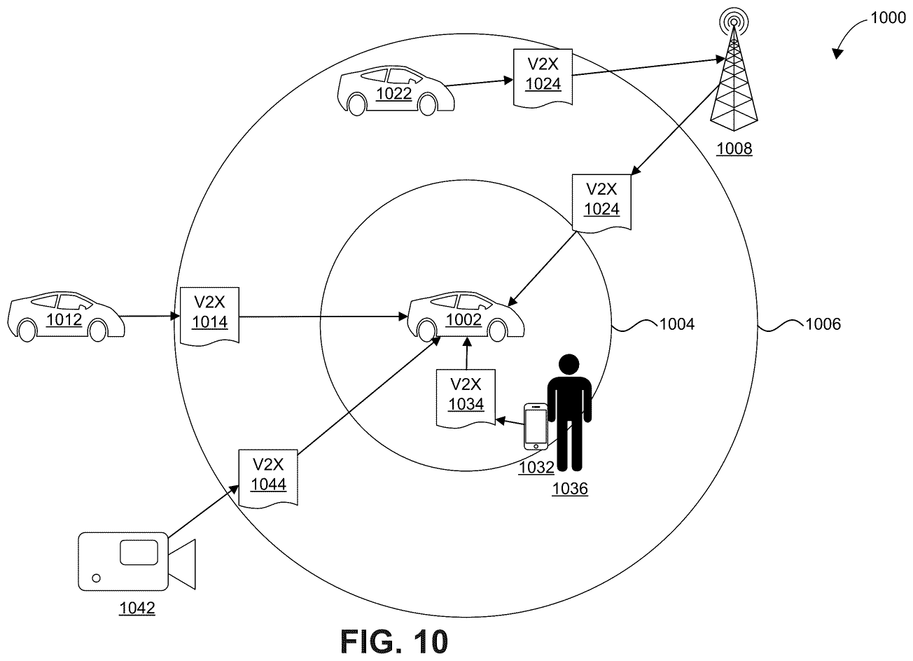

FIG. 10 is a block diagram illustrating an example environment 1000 in which a vehicle 1002 may determine and provide responses to queries, according to various aspects of the present disclosure. For example, an occupant of vehicle 1002 may query vehicle 1002 regarding environment 1000 and vehicle 1002 may determine a response and provide the response to the occupant. Vehicle 1002 may implement selector 924 and machine-learning model 936 of FIG. 9.

Vehicle 1012, vehicle 1022, UE 1032, and RSU 1042 are provided as examples of V2X message senders in environment 1000. For example, vehicle 1012 may generate and transmit V2X message 1014, vehicle 1022 may generate and send V2X message 1024, UE 1032 may generate and send V2X message 1034, and RSU 1042 may generate and send V2X message 1034. V2X message 1014 is given as an example of a direct message from vehicle 1012 to vehicle 1002 (e.g., a sidelink communication). V2X message 1024 is given as an example of a V2X message relayed by a base station (BS) 1008. V2X message 1034 is given as an example of a V2X message from a VRU (e.g., from UE 1032 of VRU 1036). V2X message 1044 is given as an example of a V2X message from an RSU (e.g., from RSU 1042). V2X message 1034 and V2X message 1044 are illustrated as being direct communications between UE 1032 and vehicle 1002 and RSU 1042 and vehicle 1002 respectively. Alternatively, V2X message 1034 and V2X message 1044 may be relayed by BS 1008.

Vehicle 1002 may receive V2X message 1014, V2X message 1024, V2X message 1034, V2X message 1044, and additional V2X messages. For example, vehicle 1002 may receive multiple instances of each of V2X message 1014, V2X message 1024, V2X message 1034, and V2X message 1044. For example, vehicle 1012 may regularly (e.g., 10 times per second) transmit instances of V2X message 1014, vehicle 1022 may regularly, transmit instances of V2X message 1024, UE 1032 may regularly transmit instances of V2X message 1034, and RSU 1042 may regularly transmit instances of V2X message 1044. Additionally, there may be additional vehicles, UEs, and/or RSUs (not illustrated in FIG. 10) in environment 1000 that may transmit V2X messages. Collectively, all V2X messages received by vehicle 1002 may be an example of V2X messages 912 of FIG. 9.

Vehicle 1002 may implement a selector (such as selector 924 of FIG. 9) to determine a subset of all the V2X messages received by vehicle 1002. Vehicle 1002 may further implement a machine-learning model (e.g., machine-learning model 936 of FIG. 2) to respond to queries based on the determined subset of V2X messages.

The selector may select V2X messages based on the proximity of the source of the selected V2X messages to vehicle 902. For example, the selector may select V2X messages from all sources within distance range 1004 (which may as distance range of 10 meters). For instance, the selector may select V2X message 1034 from UE 1032 of VRU 1036 because UE 1032 is within distance range 1004 from vehicle 1002.

As an example, the selector may select V2X messages based on the source type (or message type) and proximity. For example, the selector may select all V2X messages from sources in distance range 1004 and select all V2X messages from vehicle sources within distance range 1006. For instance, the selector may select V2X message 1034 from UE 1032 and V2X message 1024 from vehicle 1022 based on vehicle 1022 being within distance range 1006 (which may be a distance range of 20 meters) of vehicle 1002.

Additionally or alternatively, the selector may select V2X messages based on the speed (or time to collision) of sources and proximity. For example, the selector may select all V2X messages from sources in distance range 1004 and select all V2X messages from sources that are traveling at speeds above a threshold. For instance, the selector may select V2X message 1034 from UE 1032 and V2X message 1014 from vehicle 1012 based on vehicle 1012 travelling at a speed above the speed threshold or based on a time to collision between vehicle 1002 and vehicle 1012.

In some aspects, the selector may determine the sizes of distance range 1004, distance range 1006, and any additional distance ranges (not illustrated in FIG. 10) based on a speed of vehicle 1002 or based on a classification of environment 1000. For example, if environment 1000 is classified as an urban environment, distance range 1004 and/or distance range 1006 may have a relatively small diameter. For instance, distance range 1004 may have 2-meter diameter and distance range 1006 may have a 10-meter diameter. Alternatively, if environment 1000 is classified as a rural environment, (and/or if 1002 is moving above a threshold speed, such as 100 kilometers per hour) distance range 1004 and/or distance range 1006 may have a relatively large diameter. For instance, the selector may operate based on a single distance range 1004 having a 30-meter diameter. In some aspects, vehicle 1002 may use a map of environment 1000. The map may include a classification of environment 1000. In some aspects, vehicle 1002 may determine a classification of environment 1000, for example, using a machine-learning model based on images, density of V2X messages, and/or other cues.

Additionally or alternatively, in some aspects, the selector may determine the sizes of distance range 1004, distance range 1006, and any additional distance ranges (not illustrated in FIG. 10) based on an urgency of the query. For example, in some aspects, a query may be categorized according to urgency. For example, if the query relates to a maneuver that may take place in 10 seconds or less, the query may be categorized as urgent. However, if the query relates to a route planning and may not impact any maneuver or operation of the car within 1 minute, the query may be categorized as not urgent. Additionally or alternatively, if the query is general and has little or no implication for maneuvering the vehicle or changing a planned path of the vehicle, the query may be categorized as not urgent. A machine-learning model may be used to determine urgency related to the query. The selector of vehicle 1002 may determine which V2X messages are relevant based on an urgency of the query. For example, if the query is urgent, the selector may determine that V2X messages from within distance range 1004 are relevant and that V2X messages from sources beyond distance range 1004 are not relevant. Alternatively, if the query is not urgent, for example, if the query is about traffic conditions generally, or about a planned route, the selector may determine that V2X messages from sources that are beyond distance range 1006 are relevant, and in some cases, that V2X messages from sources within distance range 1006 are irrelevant.

In the present disclosure, references to trained machine-learning models performing certain actions may refer to the machine-learning model having been trained to perform the certain actions. For example, in some aspects, rather than the selector being implemented with an explicit rule, the selector may have been trained (e.g., through a supervised learning process) based on losses to follow the rule. In some aspects, machine-learning models may be implemented with explicit rules.

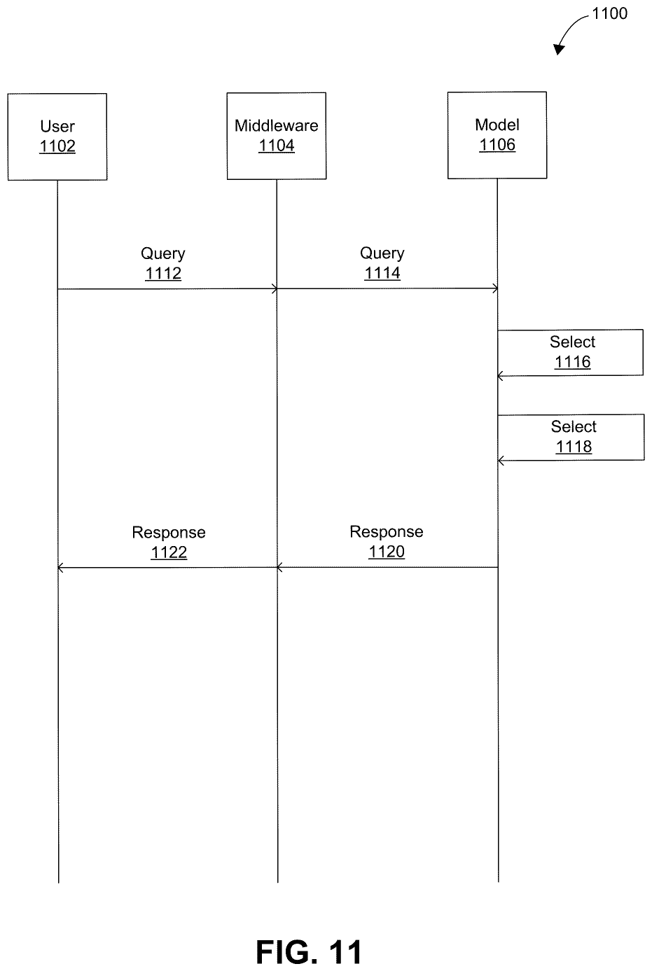

FIG. 11 is a swimlane diagram illustrating an example process 1100 for generating a response to a query, according to various aspects of the present disclosure. For example, a user 1102 may pose a query. A middleware 1104 may relay the query to a machine-learning model 1106. Machine-learning model 1106 may generate a response, and middleware 1104 may relay the response to user 1102.

User 1102 may be an occupant of a vehicle. Occupant 904 of vehicle 902 of FIG. 9 is an example of user 1102.

Middleware 1104 may be, or may include, hardware and/or software that relays a query from user 1102 to machine-learning model 1106 and relays a response from machine-learning model 1106 to user 1102. Middleware 1104 may include interfaces, such as microphones (e.g., to record spoken queries), touch screens (e.g., to receive touches as a query), language models, (e.g., to translate a spoken query into machine-interpretable language and to translate a response from machine-interpretable language into a vocalizable response), speakers (e.g., to vocalize a response), and/or displays (e.g., to display a response).

Machine-learning model 1106 may include one or more machine-learning models trained select relevant V2X messages and to process a query to generate a response to the query based on the relevant V2X messages. For example, machine-learning model 1106 may implement selector 924 and machine-learning model 936 of FIG. 9 and vehicle 1002 of FIG. 10.

At operation 1112, user 1102 may pose a query. Middleware 1104 may obtain the query (e.g., recording the query or receiving the query at an interface such as a touch screen). At operation 1114, middleware 1104 may translate the query into computer-interpretable language and provide the query to machine-learning model 1106.

In some aspects, at operation 1116, machine-learning model 1106 may select relevant V2X information from among V2X messages received by the vehicle of user 1102. For example, machine-learning model 1106 may perform operations described with relation to selector 924 of FIG. 9 and vehicle 1002 of FIG. 10.

In some aspects, at operation 1118, machine-learning model 1106 may generate a response to the query based on the relevant V2X information determined at operation 1116. For example, machine-learning model 1106 may perform operations described with relation to machine-learning model 936 of FIG. 9 and vehicle 1002 of FIG. 10.

In some aspects, at operation 1116 and operation 1118, machine-learning model 1106 may summarize a situation of an environment of the vehicle. For example, machine-learning model 1106 may summarize V2X messages received by the vehicle and provide the summary as a response to the query.

At operation 1120, machine-learning model 1106 may provide the response to middleware 1104. At response 1122, middleware 1104 may translate the response from computer-interpretable language into a format for presentation to user 1102 and provide the response to user 1102. For example, middleware 1104 may vocalize the response and play the vocalized response at a speaker. As an example, the response may be displayed at a display, for example, a heads-up display of the vehicle.

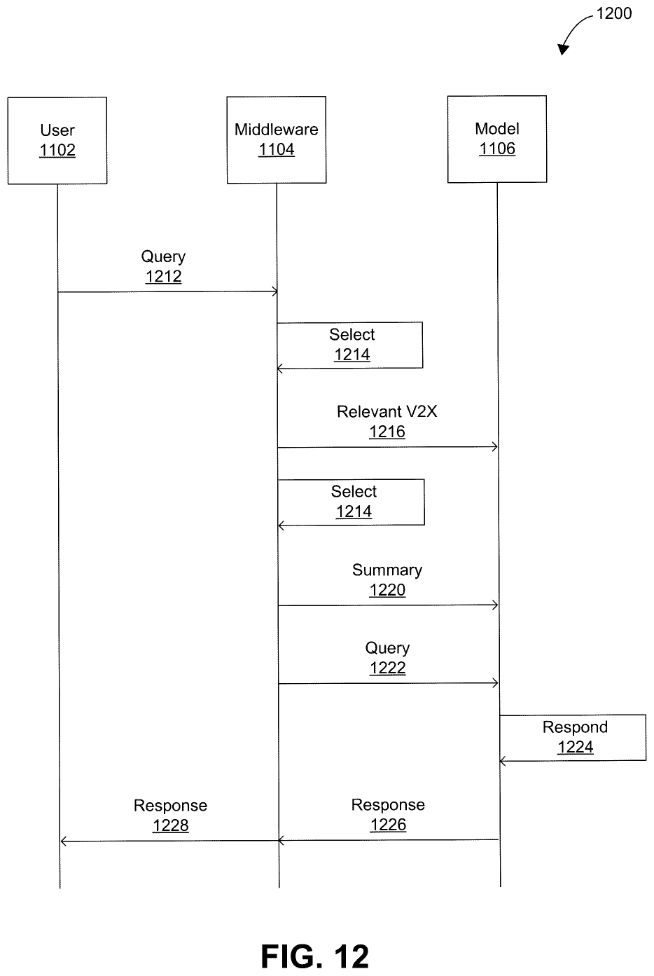

FIG. 12 is a swimlane diagram illustrating an example process 1200 for generating a response to a query, according to various aspects of the present disclosure. For example, a user 1102 may pose a query. A middleware 1104 may relay the query to a machine-learning model 1106. Machine-learning model 1106 may generate a response, and middleware 1104 may relay the response to user 1102.

At operation 1212, user 1102 may pose a query. Middleware 1104 may receive and interpret the query.

In some aspects, at operation 1214, middleware 1104 may select relevant V2X information from among V2X messages received by a vehicle of user 1102. For example, middleware 1104 may perform operations described with relation to selector 924 of FIG. 9 and vehicle 1002 of FIG. 10. In some aspects, middleware 1104 may include logic to perform selection rules. In some aspects, middleware 1104 may be, or may include, a machine-learning model trained to select relevant V2X messages. In some aspects, at operation 1216, middleware 1104 may provide relevant V2X information or an indication of relevant V2X information (e.g., an indication of V2X messages that are relevant) to machine-learning model 1106.

In some aspects, at operation 1218, middleware 1104 may summarize a situation of an environment of the vehicle. For example, middleware 1104 may summarize V2X messages received by the vehicle and provide the summary as a response to the query. In some aspects, at operation 1220, middleware 1104 may provide the summary to machine-learning model 1106.

At operation 1222, middleware 1104 may provide the query to machine-learning model 1106. At operation 1224, machine-learning model 1106 may generate a response to the query. For example, machine-learning model 1106 may perform operations described with relation to machine-learning model 936 of FIG. 9 and vehicle 1002 of FIG. 10. In some aspects, machine-learning model 1106 may determine the response based on the relevant V2X information received at operation 1216. In some aspects, machine-learning model 1106 may determine the response based on the summary received at operation 1220. In some aspects, machine-learning model 1106 may determine the summary to be the response.

At operation 1226, machine-learning model 1106 may provide the response to middleware 1104. At response operation 1228, middleware 1104 may translate the response from computer-interpretable language into a format for presentation to user 1102 and provide the response to user 1102.

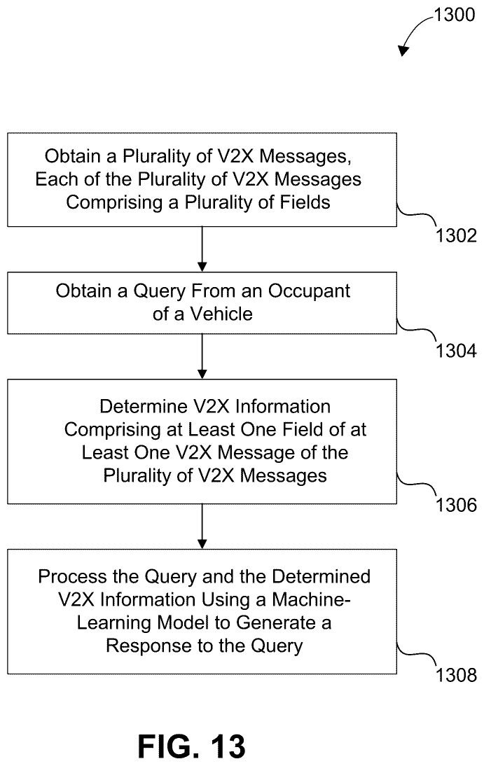

FIG. 13 is a flow diagram illustrating a process 1300 for generating a response to a query, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1300. The one or more operations of process 1300 may be implemented as software components that are executed and run on one or more processors.

At block 1302, a computing device (or one or more components thereof) may obtain a plurality of vehicle to everything (V2X) messages, each V2X message of the plurality of V2X messages comprising a plurality of fields. For example, selector 924 of FIG. 9 may obtain V2X messages 912 of FIG. 9. Each of V2X messages 912 may include a plurality of fields. For example, V2X messages 914 may be a V2X message of V2X messages 912. V2X message 914 may include fields 916.

At block 1304, the computing device (or one or more components thereof) may obtain a query from an occupant of a vehicle. For example, selector 924 may obtain query 906 of FIG. 9.

At block 1306, the computing device (or one or more components thereof) may determine V2X information comprising at least one field of at least one V2X message of the plurality of V2X messages. For example, selector 924 may determine V2X information 926 of FIG. 9. V2X information 926 may include at least one field of at least one V2X message of V2X messages 912. For example, V2X information 926 may include V2X message 928 which may correspond to V2X message 914. Fields 930 of V2X message 928 may include a subset of fields 916 of V2X message 914.

In some aspects, the at least one V2X message of the determined V2X information comprises a subset of the plurality of fields. For example, V2X information 926 may include V2X message 928 which may correspond to V2X message 914. Fields 930 of V2X message 928 may include a subset of fields 916 of V2X message 914.

In some aspects, the at least one V2X message of the determined V2X information comprises a subset of the plurality of V2X messages. For example, V2X information 926 may include a subset of V2X messages 912.

In some aspects, each V2X message of the plurality of V2X messages is from a respective vehicle of a plurality of vehicles, and wherein the subset of the plurality of V2X messages is from a subset of the plurality of vehicles. For example, V2X messages 912 may be from a plurality of sources. V2X information 926 may include V2X messages from a subset of the plurality of sources.

In some aspects, the determined V2X information is determined based on a distance between the vehicle and the subset of the plurality of vehicles. For example, selector 924 may determine the subset of the plurality of sources based on distances between vehicle 902 and the subset of the sources (e.g., as described with regard to FIG. 10).

In some aspects, each V2X message of the plurality of V2X messages is associated with a respective timestamp, and wherein the determined V2X information is determined based on timestamps of the subset of the plurality of V2X messages. For example, selector 924 may select V2X messages for inclusion in V2X information 926 based on timestamps of the V2X messages.

In some aspects, the determined V2X information is determined based on the query. For example, selector 924 may determine V2X information from among V2X messages 912 based on query 906.

In some aspects, the determined V2X information is determined based on position information of the vehicle. For example, selector 924 may determine V2X information from among V2X messages 912 based on a position of vehicle 902 (e.g., as included in vehicle information 922).

In some aspects, the machine-learning model comprises a first machine-learning model. To determine the determined V2X information, the computing device (or one or more components thereof) may process the V2X information and the query using a second machine-learning model trained to determine relevant information based on V2X information and queries. For example, selector 924 may include a second machine-learning model that may be trained to determine relevant information.

In some aspects, the second machine-learning model may be trained using contrastive-loss-based optimization. For example, the second machine-learning model of selector 924 may be trained using a contrastive-loss-based optimization.

At block 1308, the computing device (or one or more components thereof) may process the query and the determined V2X information using a machine-learning model to generate a response to the query. For example, machine-learning model 936 of FIG. 9 may process query 906 and V2X information 926 to generate response 938 to query 906.

In some aspects, to process the query and the determined V2X information using the machine-learning model, the computing device (or one or more components thereof) may provide in-context examples to the machine-learning model. For example, machine-learning model 936 may use in-context examples when generating response 938 based on query 906 and V2X information 926.

In some aspects, the response to the query comprises a summary indicative of positions of vehicles and vulnerable road users (VRUs). For example, machine-learning model 936 may generate response 938 such that response 938 includes a summary of positions of vehicles and/or VRUs.

In some aspects, the computing device (or one or more components thereof) may be, may include, or may be included in a computing device of a vehicle. For example, vehicle 902 may include a computing device that may perform process 1300.

In some aspects, the computing device (or one or more components thereof) may adjust an operating parameter of the vehicle based on the response to the query. For example, the computing device (or one or more components thereof) may adjust an operating parameter of vehicle 902.

In some aspects, the operating parameter is associated with at least one of a path for the vehicle to travel, an automatic braking parameter for operating one or more brakes of the vehicle, a lane change parameter for causing the vehicle to navigate from a first lane to a second lane, or displaying the response to the query using a user interface of the vehicle. For example, the computing device (or one or more components thereof) adjust a parameter associated with a path for vehicle 902 to travel, an automatic braking parameter for operating one or more brakes of vehicle 902, a lane change parameter for causing vehicle 902 to navigate from a first lane to a second lane, and/or displaying the response to the query using a user interface of vehicle 902.

In some examples, as noted previously, the methods described herein (e.g., process 1100 of FIG. 11, process 1200 of FIG. 12, process 1300 of FIG. 13, and/or other methods described herein) can be performed, in whole or in part, by a computing device or apparatus. In one example, one or more of the methods can be performed by system 800 of FIG. 8, system 900 of FIG. 9, vehicle 902 of FIG. 9, selector 924 of FIG. 9, machine-learning model 936 of FIG. 9, vehicle 1002 of FIG. 10, or by another system or device. In another example, one or more of the methods (e.g., process 1100, process 1200, process 1300, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 800, system 900, vehicle 902, selector 924, machine-learning model 936, vehicle 1002 and can implement the operations of process 1100, process 1200, process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

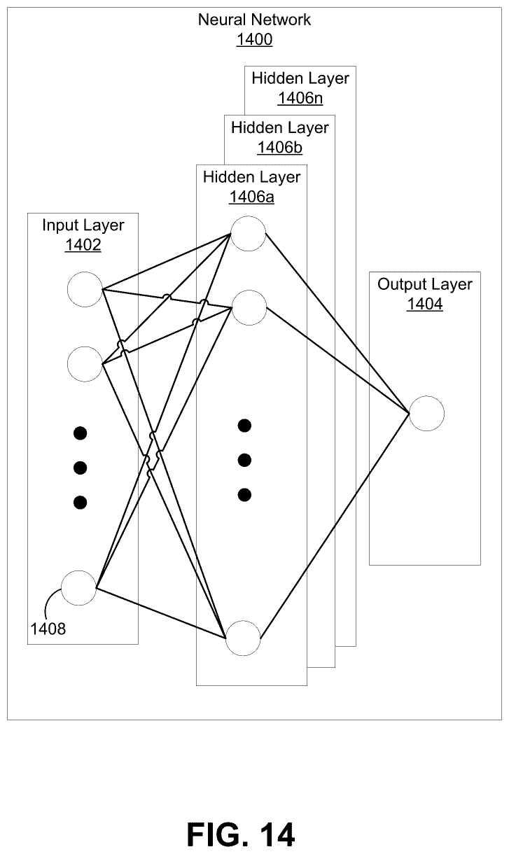

FIG. 14 is an illustrative example of a neural network 1400 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1400 may be an example of, or can implement, selector 924 of FIG. 9 and/or machine-learning model 936 of FIG. 9.

An input layer 1402 includes input data. In one illustrative example, input layer 1402 can include data representing query 906, V2X messages 912, and/or vehicle information 922. In another example, input layer 1402 may represent relevant V2X information 926 and query 906. Neural network 1400 includes multiple hidden layers, for example, hidden layers 1406a, 1406b, through 1406n. The hidden layers 1406a, 1406b, through hidden layer 1406n include “n” number of hidden layers, where “n” is an integer greater than or equal to one. The number of hidden layers can be made to include as many layers as needed for the given application. Neural network 1400 further includes an output layer 1404 that provides an output resulting from the processing performed by the hidden layers 1406a, 1406b, through 1406n. In one illustrative example, output layer 1404 can provide relevant V2X information 926. In another example, output layer 1404 can provide response 938.

Neural network 1400 may be, or may include, a multi-layer neural network of interconnected nodes. Each node can represent a piece of information. Information associated with the nodes is shared among the different layers and each layer retains information as information is processed. In some cases, neural network 1400 can include a feed-forward network, in which case there are no feedback connections where outputs of the network are fed back into itself. In some cases, neural network 1400 can include a recurrent neural network, which can have loops that allow information to be carried across nodes while reading in input.

Information can be exchanged between nodes through node-to-node interconnections between the various layers. Nodes of input layer 1402 can activate a set of nodes in the first hidden layer 1406a. For example, as shown, each of the input nodes of input layer 1402 is connected to each of the nodes of the first hidden layer 1406a. The nodes of first hidden layer 1406a can transform the information of each input node by applying activation functions to the input node information. The information derived from the transformation can then be passed to and can activate the nodes of the next hidden layer 1406b, which can perform their own designated functions. Example functions include convolutional, up-sampling, data transformation, and/or any other suitable functions. The output of the hidden layer 1406b can then activate nodes of the next hidden layer, and so on. The output of the last hidden layer 1406n can activate one or more nodes of the output layer 1404, at which an output is provided. In some cases, while nodes (e.g., node 1408) in neural network 1400 are shown as having multiple output lines, a node has a single output and all lines shown as being output from a node represent the same output value.

In some cases, each node or interconnection between nodes can have a weight that is a set of parameters derived from the training of neural network 1400. Once neural network 1400 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1400 to be adaptive to inputs and able to learn as more and more data is processed.

Neural network 1400 may be pre-trained to process the features from the data in the input layer 1402 using the different hidden layers 1406a, 1406b, through 1406n in order to provide the output through the output layer 1404. In an example in which neural network 1400 is used to identify features in images, neural network 1400 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1400 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1400 is trained well enough so that the weights of the layers are accurately tuned.

For the example of identifying objects in images, the forward pass can include passing a training image through neural network 1400. The weights are initially randomized before neural network 1400 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1400, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1400 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = {\sum }_{}^{} \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1400 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

Neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1400 can include any other deep network other than a CNN, such as an autoencoder, a deep belief nets (DBNs), a Recurrent Neural Networks (RNNs), among others.

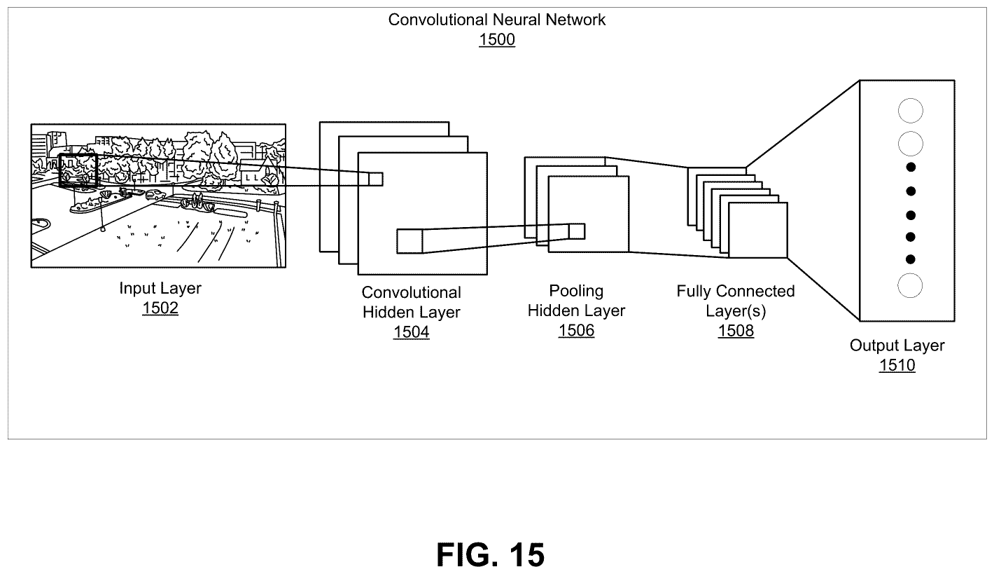

FIG. 15 is an illustrative example of a convolutional neural network (CNN) 1500. The input layer 1502 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1504, an optional non-linear activation layer, a pooling hidden layer 1506, and fully connected layer 1508 (which fully connected layer 1508 can be hidden) to get an output at the output layer 1510. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 can be the convolutional hidden layer 1504. The convolutional hidden layer 1504 can analyze image data of the input layer 1502. Each node of the convolutional hidden layer 1504 is connected to a region of nodes (pixels) of the input image called a receptive field. The convolutional hidden layer 1504 can be considered as one or more filters (each filter corresponding to a different activation or feature map), with each convolutional iteration of a filter being a node or neuron of the convolutional hidden layer 1504. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1504. Each connection between a node and a receptive field for that node learns a weight and, in some cases, an overall bias such that each node learns to analyze its particular local receptive field in the input image. Each node of the convolutional hidden layer 1504 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1504 is due to each node of the convolutional layer being applied to its corresponding receptive field. For example, a filter of the convolutional hidden layer 1504 can begin in the top-left corner of the input image array and can convolve around the input image. As noted above, each convolutional iteration of the filter can be considered a node or neuron of the convolutional hidden layer 1504. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1504. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1504.

The mapping from the input layer to the convolutional hidden layer 1504 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1504 can include several activation maps in order to identify multiple features in an image. The example shown in FIG. 15 includes three activation maps. Using three activation maps, the convolutional hidden layer 1504 can detect three different kinds of features, with each feature being detectable across the entire image.

In some examples, a non-linear hidden layer can be applied after the convolutional hidden layer 1504. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1504.

The pooling hidden layer 1506 can be applied after the convolutional hidden layer 1504 (and after the non-linear hidden layer when used). The pooling hidden layer 1506 is used to simplify the information in the output from the convolutional hidden layer 1504. For example, the pooling hidden layer 1506 can take each activation map output from the convolutional hidden layer 1504 and generates a condensed activation map (or feature map) using a pooling function. Max-pooling is one example of a function performed by a pooling hidden layer. Other forms of pooling functions be used by the pooling hidden layer 1506, such as average pooling, L2-norm pooling, or other suitable pooling functions. A pooling function (e.g., a max-pooling filter, an L2-norm filter, or other suitable pooling filter) is applied to each activation map included in the convolutional hidden layer 1504. In the example shown in FIG. 15, three pooling filters are used for the three activation maps in the convolutional hidden layer 1504.

In some examples, max-pooling can be used by applying a max-pooling filter (e.g., having a size of 2×2) with a stride (e.g., equal to a dimension of the filter, such as a stride of 2) to an activation map output from the convolutional hidden layer 1504. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1504 having a dimension of 24×24 nodes, the output from the pooling hidden layer 1506 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1506 to every one of the output nodes in the output layer 1510. Using the example above, the input layer includes 28×28 nodes encoding the pixel intensities of the input image, the convolutional hidden layer 1504 includes 3×24×24 hidden feature nodes based on application of a 5×5 local receptive field (for the filters) to three activation maps, and the pooling hidden layer 1506 includes a layer of 3×12×12 hidden feature nodes based on application of max-pooling filter to 2×2 regions across each of the three feature maps. Extending this example, the output layer 1510 can include ten output nodes. In such an example, every node of the 3×12×12 pooling hidden layer 1506 is connected to every node of the output layer 1510.

The fully connected layer 1508 can obtain the output of the previous pooling hidden layer 1506 (which should represent the activation maps of high-level features) and determines the features that most correlate to a particular class. For example, the fully connected layer 1508 can determine the high-level features that most strongly correlate to a particular class and can include weights (nodes) for the high-level features. A product can be computed between the weights of the fully connected layer 1508 and the pooling hidden layer 1506 to obtain probabilities for the different classes. For example, if the CNN 1500 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1510 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of system 800 of FIG. 8, system 900 of FIG. 9, selector 924 of FIG. 9, machine-learning model 936 of FIG. 9, vehicle 1002 of FIG. 10 and/or other devices, modules, or systems described herein. Additionally or alternatively, computing-device architecture 1600 may be configured to perform process 1100, process 1200, process 1300, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for responding to queries, the apparatus comprising: at least one memory; and at least one processor coupled to the at least one memory and configured to: obtain a plurality of vehicle to everything (V2X) messages, each V2X message of the plurality of V2X messages comprising a plurality of fields; obtain a query from an occupant of a vehicle; determine V2X information comprising at least one field of at least one V2X message of the plurality of V2X messages; and process the query and the determined V2X information using a machine-learning model to generate a response to the query.

Aspect 2. The apparatus of aspect 1, wherein the at least one V2X message of the determined V2X information comprises a subset of the plurality of fields.

Aspect 3. The apparatus of any one of aspects 1 or 2, wherein the at least one V2X message of the determined V2X information comprises a subset of the plurality of V2X messages.

Aspect 4. The apparatus of aspect 3, wherein each V2X message of the plurality of V2X messages is from a respective vehicle of a plurality of vehicles, and wherein the subset of the plurality of V2X messages is from a subset of the plurality of vehicles.

Aspect 5. The apparatus of aspect 4, wherein the determined V2X information is determined based on a distance between the vehicle and the subset of the plurality of vehicles.

Aspect 6. The apparatus of any one of aspects 3 or 5, wherein each V2X message of the plurality of V2X messages is associated with a respective timestamp, and wherein the determined V2X information is determined based on timestamps of the subset of the plurality of V2X messages.

Aspect 7. The apparatus of any one of aspects 1 to 6, wherein the determined V2X information is determined based on the query.

Aspect 8. The apparatus of any one of aspects 1 to 7, wherein the determined V2X information is determined based on position information of the vehicle.

Aspect 9. The apparatus of any one of aspects 1 to 8, wherein: the machine-learning model comprises a first machine-learning model; and to determine the determined V2X information, the at least one processor is configured to process the V2X information and the query using a second machine-learning model trained to determine relevant information based on V2X information and queries.

Aspect 10. The apparatus of aspect 9, wherein the second machine-learning model is trained using contrastive-loss-based optimization.

Aspect 11. The apparatus of any one of aspects 1 to 10, wherein, to process the query and the determined V2X information using the machine-learning model, the at least one processor is configured to provide in-context examples to the machine-learning model.

Aspect 12. The apparatus of any one of aspects 1 to 11, wherein the response to the query comprises a summary indicative of positions of vehicles and vulnerable road users (VRUs).

Aspect 13. The apparatus of any one of aspects 1 to 12, wherein the apparatus is a computing device of a vehicle.

Aspect 14. The apparatus of aspect 13, wherein the at least one processor is configured to adjust an operating parameter of the vehicle based on the response to the query.

Aspect 15. The apparatus of aspect 14, wherein the operating parameter is associated with at least one of a path for the vehicle to travel, an automatic braking parameter for operating one or more brakes of the vehicle, a lane change parameter for causing the vehicle to navigate from a first lane to a second lane, or displaying the response to the query using a user interface of the vehicle.

Aspect 16. A method for responding to queries, the method comprising: obtaining a plurality of vehicle to everything (V2X) messages, each V2X message of the plurality of V2X messages comprising a plurality of fields; obtaining a query from an occupant of a vehicle; determining V2X information comprising at least one field of at least one V2X message of the plurality of V2X messages; and processing the query and the determined V2X information using a machine-learning model to generate a response to the query.

Aspect 17. The method of aspect 16, wherein the at least one V2X message of the determined V2X information comprises a subset of the plurality of fields.

Aspect 18. The method of any one of aspects 16 or 17, wherein the at least one V2X message of the determined V2X information comprises a subset of the plurality of V2X messages.

Aspect 19. The method of aspect 18, wherein each V2X message of the plurality of V2X messages is from a respective vehicle of a plurality of vehicles, and wherein the subset of the plurality of V2X messages is from a subset of the plurality of vehicles.

Aspect 20. The method of aspect 19, wherein the determined V2X information is determined based on a distance between the vehicle and the subset of the plurality of vehicles.

Aspect 21. The method of any one of aspects 18 to 20, wherein each V2X message of the plurality of V2X messages is associated with a respective timestamp, and wherein the determined V2X information is determined based on timestamps of the subset of the plurality of V2X messages.

Aspect 22. The method of any one of aspects 16 to 21, wherein the determined V2X information is determined based on the query.

Aspect 23. The method of any one of aspects 16 to 22, wherein the determined V2X information is determined based on position information of the vehicle.

Aspect 24. The method of any one of aspects 16 to 23, wherein: the machine-learning model comprises a first machine-learning model; and to determine the determined V2X information, the at least one processor is configured to process the V2X information and the query using a second machine-learning model trained to determine relevant information based on V2X information and queries.

Aspect 25. The method of aspect 24, wherein the second machine-learning model is trained using contrastive-loss-based optimization.

Aspect 26. The method of any one of aspects 16 to 25, wherein, to process the query and the determined V2X information using the machine-learning model, the at least one processor is configured to provide in-context examples to the machine-learning model.

Aspect 27. The method of any one of aspects 16 to 26, wherein the response to the query comprises a summary indicative of positions of vehicles and vulnerable road users (VRUs).

Aspect 28. The method of any one of aspects 16 to 27, wherein the apparatus is a computing device of a vehicle.

Aspect 29. The method of aspect 28, wherein the at least one processor is configured to adjust an operating parameter of the vehicle based on the response to the query.

Aspect 30. The method of aspect 29, wherein the operating parameter is associated with at least one of a path for the vehicle to travel, an automatic braking parameter for operating one or more brakes of the vehicle, a lane change parameter for causing the vehicle to navigate from a first lane to a second lane, or displaying the response to the query using a user interface of the vehicle.

Aspect 31. A non-transitory computer-readable storage medium having stored thereon instructions that, when executed by at least one processor, cause the at least one processor to perform operations according to any of aspects 16 to 30.

Aspect 32. An apparatus for providing virtual content for display, the apparatus comprising one or more means for perform operations according to any of aspects 16 to 30.

What is claimed is:

1. An apparatus for responding to queries, the apparatus comprising:
at least one memory; and
at least one processor coupled to the at least one memory and configured to:
obtain a plurality of vehicle to everything (V2X) messages, each V2X message of the plurality of V2X messages comprising a plurality of fields;
obtain a query from an occupant of a vehicle;
determine V2X information comprising at least one field of at least one V2X message of the plurality of V2X messages; and
process the query and the determined V2X information using a machine-learning model to generate a response to the query.

2. The apparatus of claim 1, wherein the at least one V2X message of the determined V2X information comprises a subset of the plurality of fields.

3. The apparatus of claim 1, wherein the at least one V2X message of the determined V2X information comprises a subset of the plurality of V2X messages.

4. The apparatus of claim 3, wherein each V2X message of the plurality of V2X messages is from a respective vehicle of a plurality of vehicles, and wherein the subset of the plurality of V2X messages is from a subset of the plurality of vehicles.

5. The apparatus of claim 4, wherein the determined V2X information is determined based on a distance between the vehicle and the subset of the plurality of vehicles.

6. The apparatus of claim 3, wherein each V2X message of the plurality of V2X messages is associated with a respective timestamp, and wherein the determined V2X information is determined based on timestamps of the subset of the plurality of V2X messages.

7. The apparatus of claim 1, wherein the determined V2X information is determined based on the query.

8. The apparatus of claim 1, wherein the determined V2X information is determined based on position information of the vehicle.

9. The apparatus of claim 1, wherein:
the machine-learning model comprises a first machine-learning model; and
to determine the determined V2X information, the at least one processor is configured to process the V2X information and the query using a second machine-learning model trained to determine relevant information based on V2X information and queries.

10. The apparatus of claim 9, wherein the second machine-learning model is trained using contrastive-loss-based optimization.

11. The apparatus of claim 1, wherein, to process the query and the determined V2X information using the machine-learning model, the at least one processor is configured to provide in-context examples to the machine-learning model.

12. The apparatus of claim 1, wherein the response to the query comprises a summary indicative of positions of vehicles and vulnerable road users (VRUs).

13. The apparatus of claim 1, wherein the apparatus is a computing device of a vehicle.

14. The apparatus of claim 13, wherein the at least one processor is configured to adjust an operating parameter of the vehicle based on the response to the query.

15. The apparatus of claim 14, wherein the operating parameter is associated with at least one of a path for the vehicle to travel, an automatic braking parameter for operating one or more brakes of the vehicle, a lane change parameter for causing the vehicle to navigate from a first lane to a second lane, or displaying the response to the query using a user interface of the vehicle.

16. A method for responding to queries, the method comprising:
obtaining a plurality of vehicle to everything (V2X) messages, each V2X message of the plurality of V2X messages comprising a plurality of fields;
obtaining a query from an occupant of a vehicle;
determining V2X information comprising at least one field of at least one V2X message of the plurality of V2X messages; and
processing the query and the determined V2X information using a machine-learning model to generate a response to the query.

17. The method of claim 16, wherein the at least one V2X message of the determined V2X information comprises a subset of the plurality of fields.

18. The method of claim 16, wherein the at least one V2X message of the determined V2X information comprises a subset of the plurality of V2X messages.

19. The method of claim 18, wherein each V2X message of the plurality of V2X messages is from a respective vehicle of a plurality of vehicles, and wherein the subset of the plurality of V2X messages is from a subset of the plurality of vehicles.

20. The method of claim 19, wherein the determined V2X information is determined based on a distance between the vehicle and the subset of the plurality of vehicles.
